(19) United States
(12) Patent Application Publication
(10) Pub. No.: US 2025/0282205 A1
(43) Pub. Date: Sep. 11, 2025

(54) OPENABLE SIDE TARPAULIN WALL SYSTEM

(71) Applicant: European Trailer Systems GmbH, Moers (DE)

(72) Inventors: Markus LEUKERS, Moers (DE); Roger REMMEL, Moers (DE); Volker BIESENBRUCK, Moers (DE)

(21) Appl. No.: 18/859,778

(22) PCT Filed: Apr. 27, 2023
(86) PCT No.: PCT/DE2023/100308

§ 371 Date: Oct. 24, 2024

(30) Foreign Application Priority Data
Apr. 28, 2022 (DE) 10 2022 110 436.2

(51) Int. Cl. B60J 5/06; B62D 33/04

(52) U.S. Cl. CPC B60J 5/065; B62D 33/04

(57) ABSTRACT

The invention relates to an openable side tarpaulin wall system for an utility vehicle, such as a truck, a semitrailer, a transport vehicle, a trailer, a container, a railroad wagon or the like, comprising at least one sliding stanchion (12) with a stanchion suspension device (13), which is displaceable along a first chamber of a longitudinal beam supported against a loading platform, and at least one tarpaulin which at least partially closes a lateral opening of the utility vehicle and which is suspended via tarpaulin suspension devices that are displaceable along a second chamber of the longitudinal beam, wherein the stanchion suspension device (13) comprises at least two twin load-bearing rollers (33). An openable side tarpaulin wall system and a sliding stanchion for an utility vehicle, with which a side tarpaulin of the utility vehicle can be opened and closed easily and reliably and which is inexpensive to produce, is created by the stanchion suspension device (13) comprising a guide roller (34) outside each of the twin load-bearing rollers (33) in a direction of travel, wherein said twin load-bearing rollers (33) and said guide rollers (34) are arranged in the first chamber.

The invention relates to an openable side tarpaulin wall system for an utility vehicle, such as a truck, a semitrailer, a transport vehicle, a trailer, a container, a railroad wagon, or the like. The invention further relates to a sliding stanchion for a side tarpaulin wall system.

In practice, a wide variety of solutions and structures are known relating to side tarpaulin wall systems for utility vehicles. Utility vehicles, such as a truck, a trailer and a semitrailer, are mainly used to transport goods and products on public roads. For this purpose, utility vehicles include a cargo space which is provided to accommodate the goods and products to be transported. This cargo space is equipped with a side tarpaulin wall system on each side, for example.

The side tarpaulin wall system of the utility vehicle is primarily responsible for protecting a cargo from rain, dirt, weather, and other lateral influences. Furthermore, the side tarpaulin wall system must ensure that the cargo is secured, particularly during travel, for example when cornering or during emergency braking, so that the side tarpaulin wall system is always able to absorb a defined horizontal force being applied to the side tarpaulin wall system, for example by a cargo in the cargo space that has slipped.

Furthermore, a side tarpaulin wall system should have as low a deadweight as possible, so that trips are cost-effective and energy-saving. Another important aspect is the rapid opening and closing of the side tarpaulin wall system in order to keep so-called non-productive times for loading and unloading as short as possible. It is also advantageous for the side tarpaulin wall system to be able to provide the largest possible opening to a cargo space so that the loading and unloading of goods and products can be carried out almost without hindrance.

DE 197 56 617 A1 shows an openable side tarpaulin wall system for an utility vehicle, comprising at least one sliding stanchion with a stanchion suspension device that is displaceable along a first chamber of a longitudinal beam supported against a loading platform, and at least one tarpaulin segment that at least partially closes a lateral opening of the utility vehicle and that is suspended via tarpaulin suspension devices that are displaceable along a second chamber of the longitudinal beam, wherein the side tarpaulin can be connected to a corner stanchion via a keder connection.

DE 10 2020 126 429 A1 shows an utility vehicle with an openable side tarpaulin wall system, comprising at least one tarpaulin segment which at least partially closes a lateral opening of the utility vehicle, wherein the tarpaulin segment has at least one edge-side connecting element, and wherein the connecting element is connected to a corresponding counter-element of a corner stanchion. Here the connecting element of the tarpaulin segment is designed as a keder.

EP 2 708 395 A1 shows an openable side tarpaulin wall system of an utility vehicle, such as a semitrailer, comprising at least one sliding stanchion with a stanchion suspension device which is displaceable along a longitudinal beam supported against a loading platform. Here, the stanchion suspension device has a total of three horizontal guide rollers and two vertical load-bearing rollers, wherein two guide rollers are arranged in a lower chamber of the longitudinal beam, and wherein the third guide roller is arranged between the two load-bearing rollers in an upper chamber of the longitudinal beam, so that the two load-bearing rollers and the third guide roller are displaceable in the upper chamber of the longitudinal beam. Furthermore, at least one tarpaulin segment is shown, which at least partially closes a lateral opening of the utility vehicle and which is displaceable along the longitudinal beam via the same stanchion suspension device. Furthermore, in a region of the loading platform there is a guide rail which is designed to be substantially identical to the upper longitudinal beam, wherein the sliding stanchion has a sliding-stanchion carriage at its lower end which substantially corresponds to the stanchion suspension device, so that the sliding stanchion is displaceable at its lower end along the guide rail via the sliding-stanchion carriage. The tarpaulin segment is connected directly to the sliding stanchion by means of fastening devices, so that the tarpaulin segment can follow a displacement of the sliding stanchion in the longitudinal direction of the loading platform.

DE 10 2016 103 171 A1 shows an openable side tarpaulin wall system for an utility vehicle, comprising at least one sliding stanchion with a stanchion suspension device that is displaceable along a first chamber of a longitudinal beam supported against a loading platform, and at least one tarpaulin segment that at least partially closes a lateral opening of the utility vehicle and that is suspended via tarpaulin suspension devices that are displaceable along a second chamber of the longitudinal beam, wherein the stanchion suspension device has two twin load-bearing rollers.

JP H07 276 990 A shows an openable side tarpaulin wall system for an utility vehicle, comprising at least one sliding stanchion with a stanchion suspension device which is displaceable along a first chamber of a longitudinal beam supported against a loading platform, and at least one tarpaulin segment which at least partially closes a lateral opening of the utility vehicle and which is suspended via tarpaulin suspension devices which are displaceable along a second chamber of the longitudinal beam, wherein the stanchion suspension device comprises a guide roller in the direction of travel in each case, which are arranged in the first chamber.

EP 2 835 282 A1 shows a structure for a roof cover frame of an utility vehicle, comprising a cargo securing device which is displaceable along a longitudinal beam in a first chamber, wherein the cargo securing device comprises a carriage which has a first pair of twin load-bearing rollers at a first end and a second pair of twin load-bearing rollers at a second end, wherein two guide rollers are arranged between the first pair of twin load-bearing rollers and the second pair of twin load-bearing rollers, and wherein a locking device is arranged between the two guide rollers.

WO 2009 003 218 A1 shows an openable side tarpaulin wall system of an utility vehicle, comprising a side tarpaulin which is suspended from tarpaulin suspension devices which are displaceable along a chamber of a longitudinal beam, wherein a profile rail is arranged in a region of the loading platform, in which rail the lower region of the side tarpaulin can be fastened via a tensioning device, wherein a metal strip is inserted in a pocket of the side tarpaulin between the upper tarpaulin suspension device and the lower tensioning device, and wherein the metal strip is connected to the tarpaulin suspension device and the lower tensioning device via fastening means. The tarpaulin suspension device comprises a first pair of twin load-bearing rollers and a second pair of twin load-bearing rollers, wherein two horizontal guide rollers are arranged between the two twin load-bearing rollers.

DE 32 04 505 A1 discloses an openable side tarpaulin wall system of an utility vehicle, comprising a side tarpaulin which is suspended from tarpaulin suspension devices which are displaceable along an upper chamber of a longitudinal beam, wherein a guide rail with a lower chamber is arranged in a region of the loading platform, wherein the lower region of the side tarpaulin is displaceable along the guide rail via tarpaulin carriages, wherein a reinforcing strip is arranged between the upper tarpaulin suspension device and the lower tarpaulin carriages, and wherein the reinforcing strip is connected to the tarpaulin suspension device and the lower tarpaulin carriage via fastening means. Furthermore, the tarpaulin suspension device and the lower tarpaulin carriage each comprise a first pair of twin load-bearing rollers and a second pair of twin load-bearing rollers, wherein the lower tarpaulin carriage additionally has at least one horizontal guide roller.

DE 10 2011 107 377 A1 discloses an openable side tarpaulin wall system for an utility vehicle, comprising at least one height-adjustable sliding stanchion with a stanchion suspension device that is displaceable along a chamber of a longitudinal beam supported against a loading platform, and at least one tarpaulin segment that at least partially closes a lateral opening of the utility vehicle and that is suspended via tarpaulin suspension devices that are each arranged on the stanchion suspension devices, wherein the stanchion suspension device has two twin load-bearing rollers, and wherein a guide rail with a lower chamber is arranged in a region of the loading platform, in which the sliding stanchion is displaceable along the guide rail by means of a sliding-stanchion carriage.

DE 10 2017 107 583 A1 discloses a load-bearing roller for a carriage of a roof frame for a tarpaulin structure, wherein the load-bearing roller has flange regions that are suitable for absorbing horizontal forces.

DE 10 2016 103 172 A1 discloses an openable side tarpaulin wall system of an utility vehicle, comprising a side tarpaulin which is suspended from at least one tarpaulin suspension device, wherein the tarpaulin suspension device has two load-bearing rollers and at least one guide roller, wherein the load-bearing rollers are displaceable in a first chamber of a longitudinal beam, and wherein the guide roller is displaceable in a second chamber of the longitudinal beam. Here the guide roller is arranged between the two load-bearing rollers below the first chamber.

DE 10 2017 126 055 A1 discloses an openable side tarpaulin wall system for an utility vehicle. The openable side tarpaulin wall system comprises a side tarpaulin which at least partially closes a lateral opening of the utility vehicle and which is suspended via tarpaulin suspension devices which are displaceable along a longitudinal beam supported against a loading platform. The side tarpaulin has at least one edge-side connecting element, which is connected to a counter-element of a corner stanchion. The connecting element of the side tarpaulin comprises a keder which is inserted into a keder rail which is designed as a counter-element of the corner stanchion. The side tarpaulin also has straps. The disadvantage is that the side tarpaulin wall system has a side tarpaulin that can only be moved along the longitudinal beam by using tarpaulin suspension devices. The side tarpaulin includes tensioning elements on its lower horizontal edge which can be brought into engagement with the loading platform. Opening and closing the side tarpaulin therefore always requires the tensioning elements of the side tarpaulin to be operated, which makes opening and closing the side tarpaulin time-consuming. Furthermore, a side tarpaulin that is at least partially open is not fastened or tensioned at its lower edge, so that the side tarpaulin could be displaced in an uncontrolled manner.

DE 10 2006 043 655 A1 discloses an openable side tarpaulin wall system for an utility vehicle. The side tarpaulin wall system comprises at least one sliding stanchion with a stanchion suspension device which is displaceable along a chamber of a longitudinal beam supported against a loading platform. Furthermore, the side tarpaulin wall system comprises a side tarpaulin which at least partially closes a lateral opening of the utility vehicle. The side tarpaulin has connecting elements which are connected to a counter-element of the sliding stanchion. The counter-element comprises a keder rail with a groove in which the connecting element of the side tarpaulin, which is designed as a keder, is inserted. Furthermore, the side tarpaulin is attached only to the sliding stanchions. A disadvantage is that the side tarpaulin is only attached to sliding stanchions or corner stanchions, so that almost the entire weight of the side tarpaulin is carried by the sliding stanchions. This type of fastening leads to a shortened product life of the side tarpaulin, which is always exposed to high loads. Furthermore, there is a problem with sealing against rain, meltwater, and dirty water in a roof region of the utility vehicle, since the side tarpaulin is not connected to the longitudinal beam. In addition, the side tarpaulin is attached to a tensioning edge of the loading platform in one region by means of tensioning elements, which makes opening and closing the side tarpaulin time-consuming.

DE 20 2013 006 707 U1 discloses a tarpaulin for an utility vehicle, which is connected to a roof cover frame of the utility vehicle. The tarpaulin can be used either for a side tarpaulin wall system or a roof tarpaulin system of an utility vehicle. The corresponding side tarpaulin wall system comprises at least one sliding stanchion which is displaceable along a longitudinal beam supported against a loading platform. Furthermore, the side tarpaulin wall system comprises at least one tarpaulin segment which at least partially closes a lateral opening of the utility vehicle. The tarpaulin segment has at least one edge-side connecting element, which is designed as a keder. The keder of the tarpaulin segment is connected to a counter-element of the sliding stanchion, which is designed as a keder rail.

WO 2017 214 689 A1 describes an openable side tarpaulin wall system for an utility vehicle. The side tarpaulin wall system comprises at least one sliding stanchion with a stanchion suspension device which is displaceable along a longitudinal beam supported against a loading platform. Furthermore, the side tarpaulin wall system comprises a side tarpaulin which at least partially closes a lateral opening of the utility vehicle. In addition, the sliding stanchions have sliding-stanchion carriages that can be moved along a guide rail assigned to the loading platform. The side tarpaulin is connected to the sliding stanchions and has an upper edge parallel to the longitudinal beam and a lower edge parallel to the loading platform. Furthermore, the sliding stanchions have a trapezoidal cross-section, which makes it easier to guide them past an obstacle during the opening or closing of the side tarpaulin. Furthermore, folding aids for the side tarpaulin are arranged between the adjacent sliding stanchions. A disadvantage is that the side tarpaulin wall system has a continuous side tarpaulin, so that the side tarpaulin wall system, for example with regard to the sliding stanchions, comprises an unnecessarily large number of components, which increase the overall weight of the utility vehicle. Furthermore, the production and installation of the side tarpaulin wall system is time-consuming and costly.

EP 3 284 624 A1 discloses a sliding stanchion for an openable side tarpaulin wall system for an utility vehicle. The sliding stanchion comprises a sliding-stanchion body with an upper end and a lower end. Here, the upper end of the sliding-stanchion body comprises a stanchion suspension device which has at least two upper load-bearing rollers and at least one upper guide roller arranged between the two load-bearing rollers, which are arranged in a first chamber of the longitudinal beam. The stanchion suspension device is displaceable along a longitudinal beam of the utility vehicle supported against a loading platform, with additional guide rollers arranged in a second chamber of the longitudinal beam. Furthermore, the sliding stanchion comprises a sliding-stanchion carriage, which is arranged at the lower end of the sliding-stanchion body and whose load-bearing and guide rollers also require two chambers. The sliding-stanchion carriage comprises at least one lower load-bearing roller and at least one lower guide roller. A side tarpaulin of the openable side tarpaulin wall system is attached to the sliding-stanchion body of the sliding stanchion. A disadvantage is that the side tarpaulin wall system has a continuous side tarpaulin. Here an increased mechanical point load on the side tarpaulin is to be expected due to the deadweight of the side tarpaulin. Particularly, in a fastening region within the sliding stanchion, high tensile forces in the direction of travel as well as the weight of the side tarpaulin in the vertical direction act on the side tarpaulin or on the connecting elements during an opening or closing process of the side tarpaulin wall system.

It is the object of the invention to provide an openable side tarpaulin wall system and a sliding stanchion for an utility vehicle by means of which a side tarpaulin of an utility vehicle can be opened or closed easily and reliably and which can be produced cost-effectively.

This object is solved according to the invention by an openable side tarpaulin wall system with the features of independent claim 1 and by a sliding stanchion with the features of independent claim 10.

According to one aspect of the invention, an openable side tarpaulin wall system is provided for an utility vehicle, such as a truck, a semitrailer, a transport vehicle, a trailer, a container, a railroad car, or the like. The openable side tarpaulin wall system comprises at least one sliding stanchion with a stanchion suspension device which is displaceable along a first chamber of a longitudinal beam supported against a loading platform. Furthermore, the openable side tarpaulin wall system comprises at least one tarpaulin segment which at least partially closes a lateral opening of the utility vehicle and which is suspended via tarpaulin suspension devices which are displaceable along a second chamber of the longitudinal beam. Here the stanchion suspension device has at least two twin load-bearing rollers. The openable side tarpaulin wall system is characterized by the stanchion suspension device comprising a guide roller outside each of the twin load-bearing rollers in the direction of travel, which are arranged in the first chamber. By providing two twin load-bearing rollers and two guide rollers in the first chamber, it is ensured that the stanchion suspension device not only supports the mass of the sliding stanchion, but also ensures that forces normally applied to the sliding stanchion and/or a connected tarpaulin segment, whether during loading or dynamic loads of the cargo during travel, are introduced into the corresponding longitudinal beam via the load-bearing rollers.

Preferably, further twin load-bearing rollers can be arranged between the at least two twin load-bearing rollers adjacent to the guide rollers, for example one, two, three, four, five, six twin load-bearing rollers, so that the total number of twin load-bearing rollers is then correspondingly three, four, five, six, seven, or eight. The twin load-bearing rollers that are arranged in between increase the axial load capacity of the sliding stanchions and advantageously prevent the stanchion suspension device from jamming or twisting. Since the stanchion suspension devices expediently run in the first chamber, there is no risk of the stanchion suspension devices colliding with the tarpaulin suspension devices. The overall package of the opened side tarpaulin is not increased if the stanchion suspension devices do not project beyond the stanchion body by more than 1.5 times the width of a tarpaulin suspension device in the direction of travel of the tarpaulin.

According to one aspect of the invention, a sliding stanchion is provided for an openable side tarpaulin wall system for a utility vehicle, such as a truck, a semitrailer, a transport vehicle, a trailer, a container, a railroad wagon, or the like. The sliding stanchion comprises a sliding-stanchion body with an upper end and a lower end, wherein the upper end of the sliding-stanchion body comprises a stanchion suspension device, wherein the stanchion suspension device comprises at least two upper twin load-bearing rollers and at least one upper guide roller. Here the upper load-bearing rollers and the upper guide roller are displaceable in a first chamber of a longitudinal beam. The sliding stanchion is characterized by the fact that the stanchion suspension device comprises a guide roller outside each of the twin load-bearing rollers in the direction of travel. The guide rollers ensure that the sliding stanchion can be displaced without jamming. Furthermore, the two guide rollers align the sliding stanchion in such a way that the sliding stanchion can always be moved smoothly and without jamming along the longitudinal beam, even at a slight incline. In particular, the two guide rollers arranged at the front in the direction of travel allow the absorption of forces acting normally on the sliding stanchion, wherein the provision of the two guide rollers at the outer position and thus at a large distance from each other prevents a tipping moment occurring in the event of asymmetrical loading.

Expediently, the sliding stanchion has a sliding-stanchion carriage at an end opposite the stanchion suspension device, by means of which the stanchion is displaceable relative to a guide rail assigned to the loading platform. It is therefore advantageous for the sliding stanchion to be mounted and guided at the top via the stanchion suspension device and at the bottom via the sliding-stanchion carriage. A guidance at both ends of the sliding stanchion advantageously supports a jamming-free displacement of the sliding stanchion. Furthermore, the guidance at both ends prevents the sliding stanchion from being pushed out of the guideway of a longitudinal beam or out of a guide rail in the event of horizontal forces acting on the sliding stanchion. Advantageously, the sliding stanchion can then also transfer forces normally introduced into the sliding stanchion or a connected tarpaulin segment not only into the longitudinal beam but also into the guide rail, so that they can jointly absorb such loads. It is no longer necessary to remove the sliding stanchion from a stanchion base and then fasten it again manually. In this way the entire side tarpaulin can be closed very quickly. Furthermore, it is not necessary for the stanchions to be individually locked in order to connect them to the stanchion base. There is also no longer any risk of the structure being weakened by the sliding stanchions not being fixed in relation to the loading platform.

Preferably, the sliding stanchion carriages each have at least one load-bearing roller arranged above the guide rail and at least one counter-roller arranged below the guide rail. An upper and a lower support or guide roller increase the stability and robustness of the sliding stanchion. Furthermore, the sliding stanchion can absorb horizontal forces without being forced out of the guide rail. In addition, the combination of load-bearing and guide roller increases the smooth running of the sliding-stanchion carriages when moving along the guide rail, so that jamming is always prevented. The forces acting normally on the sliding stanchions are absorbed in particular by the lower counter-roller.

Preferably, the sliding stanchion has a downwardly projecting stop body at the end opposite the stanchion suspension device, which stop body is arranged on an inner side of the sliding stanchion and adjacent to the sliding-stanchion carriage. In the event that a load or an obstacle in a lower region on the inside of the sliding stanchion exerts a force against the sliding stanchion, the stop body offers additional protection against the lower sliding-stanchion carriage being forced out of the guide rail. Furthermore, the stop body offers protection against damage to the sliding-stanchion carriage of the sliding stanchion.

Expediently, the at least one tarpaulin segment has tarpaulin carriages at an end opposite the tarpaulin suspension devices, by means of which the tarpaulin segment is displaceable with respect to a guide rail assigned to the loading platform. Advantageously, the tarpaulin segment, which has a flexible tarpaulin material, is not only suspended on an upper horizontal edge but also fastened to a lower horizontal edge via tarpaulin carriages. This has the advantage that the tarpaulin segment always has a shape tensioned vertically, so that, for example, the tarpaulin material is prevented from fluttering while the utility vehicle is traveling. Particularly in a vertical orientation, the tarpaulin segment is tensioned by means of the tarpaulin suspension devices and the tarpaulin carriages, which ensures a defined folding movement when the side tarpaulin wall system is being opened or closed. The provision of tarpaulin carriages also means that the tarpaulin segments are clamped with little play at the top by means of the tarpaulin suspension device and at the bottom by means of the tarpaulin carriages, and loads acting normally on the tarpaulin segment, which are caused for example when loading with a forklift truck or during travel by centrifugal forces on the cargo, are introduced into the second chamber of the longitudinal beam or the guide rail. This advantageously ensures that these forces do not have to be introduced by the sliding stanchions alone.

Expediently, the tarpaulin carriages each have at least one load-bearing roller arranged above the guide rail and at least one counter-roller arranged below the guide rail. An upper and a lower load-bearing roller or guide roller in each case increase the stability and robustness of the tarpaulin segment. Furthermore, the tarpaulin segment can absorb horizontal forces without the tarpaulin segment being forced out of the guide rail. In addition, the combination of load-bearing roller and guide roller increases the smooth running of the tarpaulin carriages when moving along the guide rail, so that jamming is always prevented. The forces acting normally on the tarpaulin segment are absorbed in particular by the lower counter-roller.

It is expedient for the tarpaulin carriages and the sliding-stanchion carriages to be displaceable on the same guide rail. This arrangement advantageously has a compact, component-reducing and space-saving construction. Furthermore, it facilitates installation and similar or the same components can be used, making production cost-effective.

According to a preferred embodiment, the at least one tarpaulin segment is arranged between two adjacent sliding stanchions. Advantageously, sliding stanchions bound a tarpaulin segment on both sides, which gives the side tarpaulin wall system its flexibility and smooth movement.

Preferably, the at least one tarpaulin segment is connected to each of the adjacent sliding stanchions. In a particularly preferred embodiment, it is provided that the tarpaulin segment closes the entire lateral opening of the utility vehicle and is thus designed in the manner of a continuous side tarpaulin. In this case, the at least one tarpaulin segment is connected, for example riveted, to the sliding stanchions, so that when the at least one tarpaulin segment is being opened the sliding stanchions are taken along, which is also promoted by the tarpaulin carriages and the sliding-stanchion carriages being arranged so as to be displaceable on the same guide rail.

Preferably, the tarpaulin segment has at least one edge-side connecting element, wherein the connecting element is connected to a corresponding counter-element of the sliding stanchion. The tarpaulin segment can be easily, intuitively, and quickly mounted on the sliding stanchion. Furthermore, in the event of a defect, the tarpaulin segment can be quickly and easily removed from the sliding stanchion. This makes it advantageous to replace the tarpaulin segment only at the affected point of the side tarpaulin wall system, so that a time-consuming and costly replacement of the entire side tarpaulin is no longer necessary.

The connecting element is expediently designed as a keder. A keder connection offers a simple and immediately understandable solution for assembling or disassembling a tarpaulin segment. A keder is inexpensive and can be produced in many variations. One advantage of a keder connection is that a tensile force is evenly distributed over the entire keder rail, so that no tensile point load acts on the tarpaulin segment, which could eventually cause damage to the tarpaulin segment. As a result, the tarpaulin segment has an increased product life.

To simplify installation, the keder is preferably designed as a zip keder tape. A zip keder tape makes it easier to thread the tarpaulin segment into a keder rail at the edge.

Expediently, the counter-element comprises at least one keder rail, preferably made of aluminum. The keder rail is necessary for a keder connection so that the tarpaulin segment can be threaded or inserted into a groove of the keder rail at the edge. Advantageously, a keder connection is a positive connection via the insertion of a keder into a keder rail. Furthermore, the deadweight of the aluminum keder rail is significantly reduced compared to steel, so that driving an utility vehicle is more cost-effective overall. The aluminum keder rail can be easily produced by the meter through extrusion, making it extremely cost-effective.

According to a preferred embodiment, the counter-element is attached to the sliding stanchion. Advantageously, the counter-element is a separate component, which, depending on the application, is advantageously arranged on the sliding stanchion and is attached to the sliding stanchion via connecting means. This modular design offers increased ease of installation. Furthermore, the counter-element can be easily and quickly attached to the sliding stanchion.

Preferably, the keder rail has two parallel grooves for receiving a keder of a first tarpaulin segment and a keder of a second tarpaulin segment. A keder rail can therefore accommodate two tarpaulin segments at the same time. This advantageously promotes a compact and space-saving design. In particular, when the grooves for accommodating a keder are arranged close together, the appearance of a continuous tarpaulin is nearly uninterrupted, so that the tarpaulin segments can, for example, be printed across segments.

Preferably, the guide rollers are each arranged below an upper edge of the twin load-bearing rollers and above a lower edge of the twin load-bearing rollers.

Expediently, the twin load-bearing rollers each have a horizontal axis of rotation. Advantageously, the load-bearing rollers in the first chamber are arranged vertically, which enables displacement along the longitudinal beam, and at the same time the deadweight of the sliding stanchion is predominantly borne by the twin load-bearing rollers.

Preferably, the guide rollers each have a vertical axis of rotation. The guide rollers, which are arranged horizontally within the stanchion suspension device, always align the sliding stanchion into an optimal position during displacement. This ensures that the sliding stanchion can be moved smoothly and without jamming.

According to a preferred embodiment, the vertical axis of rotation is arranged in a plane between the two load-bearing rollers of the twin load-bearing rollers. This structure and this arrangement of the rollers promote an optimal alignment of the sliding stanchion as well as jamming-free displacement of the sliding stanchion, regardless of the direction in which the sliding stanchion is moved along the longitudinal beam. Preferably, the vertical axis of rotation is arranged exactly in the center between the two load-bearing rollers of the twin load-bearing rollers.

According to a preferred development, the horizontal axis of rotation of the twin load-bearing rollers is arranged below the guide rollers in each case. This arrangement advantageously offers sufficient free space for the guide roller for the sliding stanchion to always be aligned in an optimal position.

According to a preferred embodiment, the two guide rollers are arranged flush with each other. The two guide rollers are arranged flush and in alignment with each other, which enables the sliding stanchion to be moved smoothly and without jamming.

Overall, it is advantageous that the twin load-bearing rollers are arranged vertically. The weight of the sliding stanchion acts predominantly on the twin load-bearing rollers, so that the load-bearing rollers are advantageously arranged in a vertical position. On the one hand, this facilitates smooth displacement of the sliding stanchion as well as holding or carrying the sliding stanchion, since the twin load-bearing rollers can be moved along the longitudinal beam without jamming.

Preferably, the guide rollers are arranged horizontally. A horizontal arrangement of the guide rollers advantageously allows an optimal alignment of the sliding stanchion in the event of a displacement during an opening process or during a closing process of the side tarpaulin.

According to a preferred embodiment, an outer diameter of the guide roller projects beyond a width of the twin load-bearing rollers. This advantageously prevents the load-bearing rollers from coming into contact with an inner side wall of the chamber in which the twin load-bearing rollers and the guide roller are located.

Preferably, an upper edge and a lower edge of the guide roller are chamfered and/or rounded along their outer peripheral surface. On the one hand, a rounded or chamfered outer edge of the guide roller makes it easier to insert the guide roller into the first chamber of the longitudinal beam, and on the other hand a rounded or chamfered outer edge promotes a jamming-free and smooth displacement of the sliding stanchion.

According to a design variant, the sliding stanchion has, at least in portions, at least one guide element which extends from the edge of a sliding-stanchion body of the sliding stanchion. Furthermore, the guide element is preferably oriented outward in a direction away from the loading platform. In the event that a cargo in a cargo space of a utility vehicle presses against the inner side of the side tarpaulin wall system, for example due to slippage, the side tarpaulin wall system can be moved easily and smoothly, since the sliding stanchion has guide elements. The guide elements can advantageously be guided past an obstacle or object located in the cargo space. This advantageously allows the sliding stanchion to be guided past a cargo without jamming against it.

According to another aspect of the invention, an openable side tarpaulin wall system is provided for an utility vehicle, such as a truck, a semitrailer, a transport vehicle, a trailer, a container, a railroad wagon, or the like. The openable side tarpaulin wall system comprises at least one sliding stanchion with a stanchion suspension device which is displaceable along a first chamber of a longitudinal beam supported against a loading platform. Furthermore, the openable side tarpaulin wall system comprises at least one tarpaulin segment which at least partially closes a lateral opening of the utility vehicle and which is suspended via tarpaulin suspension devices which are displaceable along a second chamber of the longitudinal beam. The openable side tarpaulin wall system is characterized in that the tarpaulin segment has at least one edge-side connecting element and that the connecting element is connected to a corresponding counter-element of the sliding stanchion. The tarpaulin segment can be easily, intuitively, and quickly mounted on the sliding stanchion. Furthermore, in the event of a defect, the tarpaulin segment can be quickly and easily removed from the sliding stanchion. This makes it advantageous to replace the tarpaulin segment only at the affected point of the side tarpaulin wall system, so that a time-consuming and costly replacement of the entire side tarpaulin is no longer necessary.

The connecting element is expediently designed as a keder. A keder connection offers a simple and immediately understandable solution for installing or removing a tarpaulin segment. A keder is inexpensive and can be produced in many variations. One advantage of a keder connection is that a tensile force is evenly distributed over the entire keder rail, so that no tensile point load acts on the tarpaulin segment which could eventually cause damage to the tarpaulin segment. As a result, the tarpaulin segment has an increased product life.

To simplify installation, the keder is preferably designed as a zip keder tape. A zip keder tape makes it easier to thread the tarpaulin segment into a keder rail at the edge.

Expediently, the counter-element comprises at least one keder rail, preferably made of aluminum. The keder rail is necessary for a keder connection so that the tarpaulin segment can be threaded or inserted into a groove in the keder rail at the edge. Advantageously, a keder connection is a positive connection via the insertion of a keder into a keder rail. Furthermore, the deadweight of the aluminum keder rail is significantly reduced compared to steel, making trips with the utility vehicle more cost-effective overall. The aluminum keder rail can be easily produced by the meter through extrusion, making it extremely cost-effective.

According to a preferred embodiment, the counter-element is attached to the sliding stanchion. Advantageously, the counter-element is a separate component, which, depending on the application, is advantageously arranged on the sliding stanchion and is attached to the sliding stanchion via connecting means. This modular design offers increased ease of installation. Furthermore, the counter-element can be easily and quickly attached to the sliding stanchion.

Preferably, the keder rail has two parallel grooves for receiving a keder of a first tarpaulin segment and a keder of a second tarpaulin segment. A keder rail can therefore accommodate two tarpaulin segments at the same time. This advantageously promotes a compact and space-saving design. In particular, when the grooves for accommodating a keder are arranged close together, the appearance of a continuous tarpaulin is nearly uninterrupted, so that the tarpaulin segments can, for example, be printed across segments.

According to a preferred embodiment, a region of the tarpaulin segment outside the edge-side connecting elements is free of sliding stanchions. A first and a second tarpaulin segment are directly connected to a sliding stanchion via the counter-element, so that the tarpaulin segments are arranged in one plane. When viewed from the outside, the sliding stanchion is located behind the first and second tarpaulin segments. A transition from the first tarpaulin segment to the second tarpaulin segment is formed flush and steplessly on an outer side facing away from the utility vehicle. This advantageously promotes a streamlined shape of the side tarpaulin, which can advantageously save energy costs.

Neighboring tarpaulin segments are expediently connected to each other via a sliding stanchion. It is advantageous to connect a first and a second tarpaulin segment via a sliding stanchion. In this respect, a sliding stanchion advantageously transfers a tensile force not only to the first tarpaulin segment but also to the second tarpaulin segment, depending on the direction of travel. In addition, a connection via just one sliding stanchion offers a space-saving and compact design for a side tarpaulin wall system.

Overall, it is advantageous that a plurality of tarpaulin segments with sliding stanchions arranged between them form a side tarpaulin, and that the side tarpaulin can be tensioned at the ends in order to position the movable sliding stanchions. Advantageously, the sliding stanchion and the tarpaulin segment form a unit, whereby, depending on the direction of displacement, tensile forces are transferred from the tarpaulin segment to the sliding stanchion on the one hand and tensile forces can be transferred from the sliding stanchion to the tarpaulin segment on the other. When the side tarpaulin wall system is closed, the tarpaulin segments are always arranged tensioned and taut between two adjacent sliding stanchions. Insofar as the side tarpaulin is tensioned at the ends, the sliding stanchions will always be moved to a specific position.

The manufacturing costs of the side tarpaulin are not significantly increased compared to a conventional tarpaulin, which consists of a continuous tarpaulin segment and has to be guided past sliding stanchions or central stanchions fixed in the base region. Furthermore, the side tarpaulin can be operated in a similar way to a conventional side tarpaulin.

Preferably, adjacent tarpaulin segments are connected to each other in each case via a sliding stanchion. Furthermore, the sliding stanchions can preferably be moved into position when the tarpaulin segments are tensioned. This advantageously promotes a compact and space-saving design of the side tarpaulin wall system. Furthermore, the side tarpaulin wall system can be manufactured cost-effectively, since the number of components is reduced. Advantageously, the sliding stanchions are always in a defined position, so that a reliable stability of the side tarpaulin wall system is guaranteed.

Preferably, adjacent tarpaulin segments are connected to each other via a sliding stanchion in each case, and when the tarpaulin segments are being tensioned the sliding stanchions can be moved into position. As a result, the tarpaulin segments and the sliding stanchions form a force chain which, when subjected to lateral tension, transfers and distributes this tension to all links of the chain. This advantageously prevents different regions of the side tarpaulin from being subjected to different tensions.

Overall, it is advantageous that a plurality of tarpaulin segments together form a side tarpaulin and that at least one edge tarpaulin segment can be connected to a tensioning device in order to tension the side tarpaulin. A plurality of tarpaulin segments arranged next to each other advantageously form a side tarpaulin, which makes it possible to completely close a lateral opening of the utility vehicle. The side tarpaulin is tensioned by means of a tensioning device, which is advantageously arranged on a tarpaulin segment.

When the tarpaulin is closed, the tarpaulin segments are preferably arranged in a common vertical plane. The tarpaulin segments are advantageously arranged flush or steplessly relative to one another. Furthermore, the tarpaulin segments are arranged parallel next to each other. This benefits the external appearance, for example, if an outer side of the side tarpaulin is printed or coated with advertising. Uniform spacing and flush tarpaulin segments promote an overall impression of high quality of the side tarpaulin wall system.

During tensioning of the side tarpaulin, tarpaulin tension is expediently introduced into the tarpaulin segments via the sliding stanchions. Because the sliding stanchions advantageously absorb and also transmit part of the tensile forces, the tensile forces are advantageously transmitted evenly to the adjacent tarpaulin segments and to the adjacent sliding stanchions. As a result, the sliding stanchions can always be moved evenly and without disruptive effects such as jamming, thus always promoting reliable opening and closing of the side tarpaulin. Furthermore, the tension also brings about the positioning of the sliding stanchions.

Preferably, when the side tarpaulin is being opened, the sliding stanchions of the tarpaulin segments are also moved. The advantage is that an enormous amount of time is saved during opening of the side tarpaulin, since the sliding stanchions are automatically moved almost simultaneously with the tarpaulin segments. As a result, there is immediate, free side access to the cargo space of the utility vehicle.

According to a preferred embodiment, the tarpaulin segments are connected to one another exclusively via a counter-element connected to the sliding stanchion, which counter-element preferably has two parallel grooves. The counter-element is designed as a separate component, preferably in the form of a grooved rail made of aluminum as described above, which, depending on the application, can be arranged at any point on the sliding stanchion and can be connected via suitable connecting means. A total of two tarpaulin segments can advantageously be connected via the two parallel keder grooves. This offers a compact and simple solution, which is characterized by a high degree of ease of installation. Preferably, the counter-element is a one-piece part that extends over the height of the tarpaulin segment, but it is also possible to provide a plurality of preferably abutting segments of counter-elements instead of the one-piece part.

According to a further preferred embodiment, on the edge the tarpaulin segments have an at least predominantly continuous keder, which is accommodated in the counter-element. Furthermore, preferably only the keder transmits the tensioning forces. Advantageously, uniform tensioning forces act on the edge of the tarpaulin segment, so that as a result the tarpaulin segment in a closed state will be without folds. Furthermore, an interaction between a tarpaulin segment and a sliding stanchion connected to the tarpaulin segment is advantageously characterized in that any tensile forces or tensioning forces are transmitted over the entire edge-side connection between the sliding stanchion and the tarpaulin segment, whereby on the one hand a tarpaulin material of the tarpaulin segment is not subjected to point stress and on the other hand the sliding stanchion can always be moved in an upright position without jamming.

This promotes quiet and reliable opening and closing of the side tarpaulin and an increased product service life of the side tarpaulin wall system.

It is expedient for adjacent tarpaulin segments to each be connected to the same sliding stanchion via an edge-side connecting element of the corresponding tarpaulin segment. This offers the advantage of a compact and space-saving design. Overall, this allows components to be reduced and costs to be saved.

According to a further preferred embodiment, the tarpaulin segments have vertical and/or horizontal tensile reinforcements. When the side tarpaulin is being opened or closed, tensile forces arise which act on the tarpaulin segments. These tensile forces could cause the tarpaulin segment to become overstretched. In this respect, the tensile reinforcements advantageously serve to ensure that the tarpaulin segment is not overstretched and thus not damaged, thus ensuring an increased product service life.

According to a preferred embodiment, the sliding stanchion is guided at both ends without jamming. In order to make opening and closing the side tarpaulin smooth and quiet, the sliding stanchion can always be moved in an upright position.

According to one embodiment, the tarpaulin segment comprises a strap material at least in portions. The strap material advantageously increases the stability of the tarpaulin segment against a possible overstretching of a tarpaulin material of the tarpaulin segment, so that as a result the tarpaulin segment can absorb higher tensile forces. Furthermore, the strap material advantageously gives the tarpaulin segment a defined shape. During an opening or closing process, the tarpaulin segment always folds or unfolds in the manner of an accordion. The tarpaulin segment always maintains an even and identical fold, so that the tarpaulin material is advantageously protected by the strap material. This allows the side tarpaulin wall system to be opened and closed smoothly, while the tarpaulin segment has an increased product life.

Expediently, the tarpaulin segment comprises a strap material at least in portions.

The strap material expediently contains aramid fibers at least in portions. This advantageously considerably increases the stability and tensile strength of the tarpaulin segment. The tarpaulin segment can advantageously absorb or transmit even higher tensile forces, so that the side tarpaulin wall system can also be used for the highest loads. The aramid fibers are preferably woven at least in the end regions of the straps.

Preferably, the strap material reduces the stretchability of the tarpaulin segment. The strap material advantageously prevents unwanted overstretching of the tarpaulin segment, so that the tarpaulin segment always maintains a precisely defined shape. Furthermore, tensile forces are mainly introduced into the strap material, which prevents overstretching or even tearing of the tarpaulin material.

According to a preferred embodiment, the strap material is sewn onto and/or welded to the tarpaulin segment. Sewing and/or welding offer the advantage of ensuring a particularly high level of sturdiness of this connection. The tarpaulin segment is advantageously durable and designed to be safe and reliable. Furthermore, sewing and/or welding can be carried out easily and inexpensively, so that the side tarpaulin wall system design is both cost-effective and efficient.

According to a further preferred embodiment, the strap material is arranged in at least one pocket of the tarpaulin segment. This type of covering of the strap material advantageously protects the strap material when the tarpaulin segment is being displaced. This increases the durability of the connection between the strap material and the tarpaulin segment, thereby ensuring greater overall reliability and stability by advantageously preventing chafing of the strap material.

It is expedient for the strap material to be connected to the tarpaulin suspension device at least in portions. Due to the fact that increased tensile forces act on the tarpaulin segment in a region of the connection between the tarpaulin suspension device and the tarpaulin segment, the strap material is advantageously used here as reinforcement. Advantageously, tensile forces are at least predominantly introduced into the strap material, which relieves the load on the tarpaulin material and protects it.

According to one embodiment variant, the strap material is designed as at least one strap strip. Strap strips can be easily and quickly attached to a tarpaulin segment, making production and storage cost-effective.

Overall, it is advantageous for a plurality of strap strips to be connected vertically and horizontally to each tarpaulin segment. The tensile forces acting predominantly on the tarpaulin segment act on the tarpaulin segment from a horizontal as well as a vertical direction. By arranging the strap strips vertically and horizontally on the tarpaulin segment, tensile forces are optimally absorbed and diverted, thereby protecting the tarpaulin segment or the tarpaulin material of the tarpaulin segment from undesirable overstretching. Furthermore, the tensile forces are optimally transferred from the tarpaulin segment to adjacent sliding stanchions, ensuring that the side tarpaulin wall system opens and closes smoothly and evenly.

According to a preferred embodiment, the strap strips are arranged in a checkerboard pattern. A checkerboard pattern offers the advantage that this geometric arrangement can be produced easily and quickly, and that at the same time, particularly within the intersecting points of the strap strips, increased tear resistance and stability against tensile forces and possible overstretching of the tarpaulin segment are ensured. As a result, the tarpaulin segment has an increased loading limit.

According to a further preferred embodiment, the strap strips are arranged at defined distances from one another. In order to ensure that tensile forces can be evenly transmitted from the tarpaulin segment and that a tarpaulin segment can be produced economically, the strap strips have a specific spacing both next to each other and one over the other.

Preferably, the sliding stanchion has at least one guide element, at least in portions, which extends from the edge of the sliding-stanchion body, and the guide element is oriented outwardly in a direction away from the loading platform. The guide elements are advantageously provided over the entire height of the sliding-stanchion body and form a type of wedge on each of its two end faces pointing in the direction of travel, with the surface of the wedge pointing away from the utility vehicle. If the sliding stanchion is moved, the front wedge in the direction of travel is first moved along the load with its tip at the maximum distance from the utility vehicle and then with the wedge surface adjacent to the tip, wherein, in the case of an overhanging load, the guide element is gradually pushed away from the utility vehicle by means of the wedge surface. At the same time, the stanchion suspension device exerts a counterforce on the cargo in order to move it out of the travel path. This makes it easy to overcome overhanging loads without the sliding stanchion having to be swung away from the utility vehicle in the manner of a pendulum.

Expediently, the guide element and the sliding-stanchion body are made in one piece. This advantageously eliminates the need for complex installation of a guide element. In addition, manufacturing costs are reduced. Such a one-piece part can be produced, for example, by folding a sheet metal material.

Preferably, the guide element forms at least one wing-like edge of the sliding-stanchion body in the longitudinal direction of the sliding stanchion. Advantageously, the guide element frames the entire sliding-stanchion body on both sides so that the sliding stanchion can be successfully guided past an obstacle at any point, regardless of the direction in which the sliding stanchion is moved.

According to a preferred embodiment, the guide element is designed as a folded edge of the sliding-stanchion body. A folded edge can be produced easily and inexpensively. Furthermore, a folded edge provides very good stability, so that the sliding stanchion can always be guided safely and reliably past an obstacle during relocation.

The guide element expediently has rounded and/or chamfered outer edges. Because the sliding stanchion can come into contact with a tarpaulin segment, it is advantageous that the outer edges of the guide element are rounded and/or chamfered. This means that the tarpaulin material of the tarpaulin segment will not be damaged, thus ensuring increased product life.

Overall, it is advantageous that the guide element is bent in such a way that it defines a cavity. Advantageously, the guide element is arranged compactly and in space-saving fashion on the sliding-stanchion body.

According to another preferred embodiment, the guide element has a triangular cross-section. On the one hand, a triangular shape is easy to produce, and on the other hand the triangular shape allows the sliding stanchion to be easily guided past an obstacle in a ramp-like manner without jamming against the obstacle.

According to one embodiment, the guide element has at least one blunt outer edge with a radius in the longitudinal direction. The sliding stanchion has no sharp or pointed outer edges, so that the tarpaulin segment cannot be damaged. In this respect, a reliable and safe movement of the sliding stanchion is guaranteed.

Expediently, the guide element has a smooth front surface facing outward in the longitudinal direction. When the sliding stanchion is moved, it may happen that it comes into contact with a tarpaulin segment, which could cause the tarpaulin material of the tarpaulin segment to become roughened or abraded over time. A smooth surface offers the advantage that the tarpaulin material of the tarpaulin segment is protected, which advantageously increases the service life of the tarpaulin segment.

Expediently, the tarpaulin segment is arranged parallel to the front surface of the guide element in a closed state. The guide element advantageously offers shaping support with regard to the tarpaulin segment. Furthermore, the tarpaulin segment can be optimally tensioned without unwanted folds arising. Furthermore, tensile forces can be transferred evenly from the sliding stanchion to the tarpaulin segment or from the tarpaulin segment to the sliding stanchion.

Preferably, the tarpaulin segment abuts the front surface when closed. The front surface of the guide element advantageously offers the tarpaulin segment a kind of support surface, so that the tarpaulin segment is given a defined shape.

The tarpaulin segment is advantageously arranged so that the edges are smooth and wrinkle-free, so that tensile forces can be transmitted very well. Furthermore, the guide element supports a uniform folding or unfolding of the tarpaulin segment, which always ensures a reliable and smooth opening or closing of the side tarpaulin wall system.

Overall, it is advantageous that the tarpaulin segment connected to the sliding stanchion has in its edge region a lateral tarpaulin suspension device that overlaps the sliding stanchion. Advantageously, the sliding stanchions are thus no longer visible, since the corresponding tarpaulin segments are arranged in front of the sliding stanchions. The sliding stanchions are therefore located between the cargo space and the connected tarpaulin segments. A further advantage is that when the side tarpaulin wall system is closed or tensioned, there is no need for an additional locking of the sliding stanchions, which saves time when opening or closing the side tarpaulin wall system.

Preferably, the stop body is riveted and/or screwed to the sliding stanchion. Depending on the application, the stop body can be quickly and easily connected to the sliding stanchion. This modular design offers advantageously variable design options, which ensures a high level of ease of installation.

According to an alternative design, the stop body is connected to the sliding stanchion via a plug-in system. In this case, the stop body can advantageously be connected to the sliding stanchion for example via a plug-in latching connection. The advantage is that the stop body can be attached to or removed from the sliding stanchion quickly and easily without tools.

Preferably, each tarpaulin carriage is arranged opposite a tarpaulin suspension device. During an opening or closing process of the side tarpaulin wall system, this advantageously promotes the desired folding of the tarpaulin segment.

According to a favorable embodiment, however, no tarpaulin carriage is arranged opposite the lateral tarpaulin suspension device. Because there is a keder, or a connecting element, on the edge of the tarpaulin segment, it is not necessary to arrange a tarpaulin carriage at the bottom of a horizontal edge of the tarpaulin segment, since the keder connection of the tarpaulin segment with the sliding stanchion is sufficient to keep the tarpaulin segment in the desired shape in this region. The number of components is advantageously reduced, which saves costs and assembly time. In particular, this makes it possible to connect the tarpaulin carriages and the sliding-stanchion carriages to the same guide rail.

According to a preferred embodiment, at least two tarpaulin carriages are arranged between adjacent sliding-stanchion carriages. Because a tarpaulin segment has at least two tarpaulin carriages, preferably at least four and usually between six and twelve tarpaulin carriages, which are displaceable along the guide rail, the tarpaulin segment can advantageously be moved evenly and without jamming. Furthermore, when closed, the tarpaulin segment is tensioned in a vertical direction by means of the tarpaulin carriages, so that fluttering of the tarpaulin segment during travel is prevented.

According to another preferred embodiment, the load-bearing rollers and/or the counter-rollers are detachably connected to the corresponding carriages by screws. This has the advantage of allowing defective rollers to be replaced very quickly and easily.

Overall, it is advantageous that the load-bearing rollers and/or the counter-rollers have a central running surface in contact with a narrow side of the guide rail, and that the load-bearing rollers and/or the counter-rollers are provided with a radially projecting collar on both sides of the running surface, which can be brought into contact with a broad side of the guide rail in order to absorb horizontal forces. The load-bearing rollers or counter-rollers are designed in such a way that they can be brought optimally into contact with the guide rail and are displaceable along the guide rail, whereby the tarpaulin segment and the sliding stanchion can be moved smoothly and without jamming.

Furthermore, the load-bearing rollers or counter-rollers can absorb horizontal forces without the tarpaulin carriage or the sliding-stanchion carriage being forced off of the guide rail. The collar can be formed perpendicular to the central running surface. Preferably, however, the collars are at a small angle to the vertical in order to improve the mobility of the rollers, to be able to better follow deformations of the guide rail, and to prevent jamming.

According to one embodiment, the tarpaulin segment comprises at least one tension-resistant reinforcement strip. Advantageously, tensile forces acting on the tarpaulin segment can be diverted in a defined manner via the reinforcement strips without damaging the tarpaulin segment.

Preferably, the reinforcement strip is sewn and/or welded to the tarpaulin segment. This connects the reinforcement strip to the tarpaulin segment in a simple and cost-effective manner.

According to a design variant, the reinforcement strip, at least in portions, comprises a strap. This combination promotes elastic stretching of the tarpaulin segment, which means that the tarpaulin segment can be equipped with different reinforcement strips depending on the application.

Expediently, the tarpaulin segment comprises at least one pair of reinforcement plates designed as a folding aid. The pair of reinforcement plates advantageously serves to coordinate the folding or unfolding of the tarpaulin segment during the opening or closing process of the side tarpaulin wall system.

According to a preferred embodiment, the at least one pair of reinforcement plates is welded and/or sewn to the tarpaulin segment. This provides a simple and cost-effective way of creating a connection between the reinforcement plate pair and the tarpaulin segment.

According to a further preferred embodiment, the at least one reinforcement plate pair is produced from a tarpaulin material. Advantageously, the same tarpaulin material can be used for the reinforcement plate pair as for the tarpaulin segment, so that costs can be saved. Furthermore, this facilitates welding to the tarpaulin segment, thereby providing a stable, materially bonded connection.

Overall, it is advantageous that a wall thickness of the at least one reinforcement plate pair is greater than a wall thickness of the tarpaulin segment. By providing an increased wall thickness of the reinforcement plate pair, a defined weight can be set in a lower region of the tarpaulin segment so that folding or unfolding of the tarpaulin segment takes place in a coordinated manner.

Preferably, at least one pair of reinforcing plates of the tarpaulin segment is arranged adjacent to the tarpaulin carriages. On the one hand, this advantageously results in optimal folding or unfolding, and on the other hand the pair of reinforcement plates serves as a protective element against wear in a region of the guide rail, so that this increases the service life of the tarpaulin segment by protecting the tarpaulin segment from chafing.

Preferably, at least one pair of reinforcement plates is assigned to each tarpaulin carriage. The pair of reinforcement plates advantageously facilitates the tarpaulin segment folding and unfolding in a coordinated, uniform and accordion-like manner.

According to one variant embodiment, the tarpaulin segments are printed. Advantageously, the tarpaulin segments can be coated or printed on an outer side of the tarpaulin segments in order to provide advertising or promotion for the public.

Preferably, the tarpaulin segment can be folded in the manner of an accordion. In this case, in particular each tarpaulin segment advantageously folds into a plurality of folds when opened, in particular between two and twelve folds, preferably between four and eight folds, wherein in particular a vertical strap of the tarpaulin segment forms a portion of the fold remaining in the plane of the closed tarpaulin, and wherein in particular a portion of the tarpaulin segment arranged between a pair of reinforcing plates forms a foldover of the fold, wherein preferably the foldovers of the folds run vertically in a plane parallel to the plane of the closed tarpaulin. A uniform accordion-like folding allows the largest possible opening to the cargo space of an utility vehicle, provided the side tarpaulin is open. Furthermore, it ensures that the side tarpaulin wall system can be opened and closed easily. In addition, coordinated folding of the tarpaulin segment increases its service life. Due to the even accordion-like folding, the lateral overhang is minimal when the side tarpaulin is open.

According to a preferred embodiment, all load-bearing rollers and guide rollers of the stanchion suspension device are arranged in the first chamber. Furthermore, preferably all load-bearing rollers of the tarpaulin suspension device are arranged in the second chamber. The first chamber and the second chamber are expediently spaced apart from each other. Advantageously, the tarpaulin segment and the sliding stanchions can be guided along only one longitudinal beam. This offers a compact and space-saving design. In addition, sliding stanchions and tarpaulin segments can be removed or replaced independently of one another from the longitudinal beam, thus providing increased ease of installation.

Overall, it is advantageous that the tarpaulin suspension device has a guide roller which is supported against an outer wall of the longitudinal beam and that the outer wall of the longitudinal beam is arranged above the first chamber. By means of the guide roller, the tarpaulin segment is, among other things, held at a distance from the longitudinal beam, thereby preventing wear of the tarpaulin segment. This increases the product life of the tarpaulin segment, as chafing of the tarpaulin material is prevented.

Preferably, the tarpaulin suspension devices are equipped with springs, for example in that two axially guided parts are pretensioned in a tensioned direction by at least one tension spring. Advantageously, when the tarpaulin segment is moved, possible overstretching of the tarpaulin material of the tarpaulin segment is avoided or compensated for, since the springs used in the tarpaulin suspension devices always ensure a dynamic distance compensation between the tarpaulin segment and the tarpaulin suspension device. As a result, shifting the tarpaulin segment is protective of the material and thus has a positive effect on the service life of the product.

According to another preferred embodiment, the outer wall of the longitudinal beam is arranged below the second chamber. This arrangement advantageously promotes an optimal folding and unfolding of the tarpaulin segment. Furthermore, the tarpaulin segment is advantageously always arranged at a distance from the longitudinal beam, so that the tarpaulin material does not rub against the longitudinal beam on an inner side of the tarpaulin segment.

Expediently, the sliding-stanchion body comprises at least one keder rail. The keder rail advantageously enables quick and easy attachment and connection of, for example, a tarpaulin segment or a tensioning device, each of which has a corresponding keder.

According to a preferred embodiment, the sliding-stanchion body has a preferably central recess into which the at least one keder rail can be inserted. Furthermore, when the keder rail has been inserted, one end face of the keder rail is at least largely flush with one front face of the sliding stanchion body. The sliding stanchion is advantageously very easy to install since the keder rail is connected within the recess of the sliding stanchion with a precise fit. Furthermore, a space-saving and compact sliding stanchion is provided, in which the keder rail can be integrated almost invisibly. The fact that the sliding stanchion and the keder rail have a flush front surface when installed advantageously prevents a tarpaulin segment from chafing along an unwanted edge during an opening or closing process.

Preferably, the at least one keder rail extends over the effective height of the sliding-stanchion body. This advantageously allows material and weight to be saved or reduced, thus providing an economically advantageous combination of sliding stanchion and keder rail.

The further features of the sliding stanchions described above in connection with the side tarpaulin wall system according to the invention, as well as their advantages and properties, can also be implemented in a sliding stanchion according to the invention and are hereby expressly included.

According to one aspect of the invention, a method for manufacturing an openable side tarpaulin wall system for an utility vehicle, such as a truck, a semitrailer, a transport vehicle, a trailer, a container, a railroad car, or the like is provided. The method comprises providing a tarpaulin segment with a keder on the edge, inserting the keder into a groove of a keder rail, and attaching the keder rail to a sliding stanchion. The above method has two significant advantages. On the one hand, a side tarpaulin can be provided quickly, efficiently, and economically, and on the other hand if there is a defect in, for example, a tarpaulin segment or a sliding stanchion, it can be easily replaced.

The method according to the invention therefore first connects the keder of the tarpaulin segments to the keder rails and thus creates a continuous chain of alternating tarpaulin segments and keder rails. Only then are the keder rails attached to the stanchion bodies of the sliding stanchions, which for this purpose can in particular already be arranged on the longitudinal beam and/or on the guide rail. However, it is also possible to attach the keder rail to the corresponding sliding stanchion immediately after connecting the tarpaulin segments to the channel rail, which expediently has two grooves for this purpose, and then to continue with the keder of the tarpaulin segment facing away from the keder rail and another keder rail.

Expediently, tarpaulin suspension devices are connected to the tarpaulin segment. Tarpaulin suspension devices are preferably used to hold and move the tarpaulin segment so that the tarpaulin segment always maintains a desired shape. Furthermore, the tarpaulin suspension devices mainly bear the deadweight of the tarpaulin segment. Attaching the tarpaulin suspension devices advantageously takes place before the tarpaulin segment is prepared, so that the tarpaulin segment has already been provided with the tarpaulin suspension devices before the keder is inserted. This is advantageous especially if the tarpaulin segment comprises straps extending vertically from the tarpaulin suspension devices, since the tarpaulin suspension devices can be better connected to the straps before the tarpaulin segment is provided. It is possible to suspend the tarpaulin segments with the tarpaulin suspension devices from a longitudinal beam before its keder is inserted into the keder rail.

According to a preferred embodiment, the tarpaulin suspension devices are connected to the tarpaulin segment before the keder is inserted into the groove. Pre-assembled tarpaulin segments can be connected to the side tarpaulin wall system even more quickly, thereby ensuring ease of assembly.

Preferably, tarpaulin carriages are connected to the tarpaulin segment. By connection of tarpaulin carriages, the tarpaulin segment is always kept in its shape along the guide rail. Furthermore, fluttering during travel is advantageously avoided. Furthermore, the opening or closing process of the tarpaulin segment is always coordinated and smooth.

According to a further preferred embodiment, the tarpaulin carriages are connected to the tarpaulin segment before the keder is inserted into the groove. In order to save time, a tarpaulin segment can advantageously be delivered pre-assembled with a connected tarpaulin carriage, so that the tarpaulin segment can be quickly exchanged or connected to a sliding stanchion. Accordingly, the tarpaulin carriages can already have been pushed onto the guide rail before the keder of the tarpaulin segment is connected to the keder rail.

Overall, it is advantageous for the keder rail to be attached to the sliding stanchion by riveting. A riveting process ensures a particularly high level of stability of the connection between the keder rail and the sliding stanchion.

According to one design variant, the keder is connected to the tarpaulin segment at the edge by sewing, welding, gluing, or combinations thereof. The keder is connected to the tarpaulin segment using conventional methods, thus providing a cost-effective and reliable connection.

According to another preferred embodiment, the keder has a keder fin to which the tarpaulin segment is connected at the edge by sewing, welding, gluing, or combinations thereof. A keder fin facilitates a connection to the tarpaulin segment. Furthermore, the keder can be easily exchanged without damaging the tarpaulin segment or its tarpaulin material.

According to another aspect of the invention, a method for manufacturing an openable side tarpaulin wall system for an utility vehicle, such as a truck, a semitrailer, a transport vehicle, a trailer, a container, a railroad car, or the like is provided. The method comprises providing a tarpaulin segment with an edge-side keder rail having at least one groove. The method further comprises inserting a corresponding connecting element into the groove of the keder rail. Depending on the application, here the tarpaulin segment can advantageously be equipped with a keder rail. In this way, the tarpaulin wall system offers increased flexibility and ease of installation.

Preferably, the keder rail is attached to the tarpaulin segment at the edge by sewing, welding, gluing, or combinations thereof. The connection of the keder rail with the tarpaulin segment is to this extent advantageously a stable and reliable connection. Furthermore, the connection is cost-effective and efficient.

Overall, it is advantageous that the keder rail has a keder tape with which the tarpaulin segment is connected at the edge by sewing, welding, gluing, or combinations of these. When the keder rail is replaced, the keder tape is cut through. As a result, the tarpaulin segment or its tarpaulin material is not damaged.

Preferably, the corresponding connecting element is designed as a longitudinally extended rod or as a longitudinally extended tube, which is connected to a sliding stanchion via a screw connection and/or welding. The corresponding connecting element is advantageously a separate component which is attached to the sliding stanchion. In this respect, this method advantageously offers increased flexibility and ease of installation.

According to one embodiment, the corresponding connecting element is designed as a bend or projection extending from a sliding stanchion. Here the corresponding connecting element is formed in one piece with the sliding stanchion. The advantage is that components are reduced overall, thereby reducing costs. Furthermore, a one-piece connecting element is very sturdy, providing a reliable and safe side tarpaulin wall system.

Expediently, at least one pair of reinforcement plates designed as a folding aid is sewn and/or welded to an inner side and/or an outer side of the tarpaulin segment. If the tarpaulin segment requires additional pairs of reinforcement plates, these can be attached to the tarpaulin segment during assembly. This advantageously increases the ease of installation and the flexibility of the tarpaulin segment.

Preferably, in the method, the sliding stanchion is designed as described above.

As an immediate product of the method, the above manufacturing process creates a side tarpaulin wall system that is easy to manufacture, easy to operate and reliable. Accordingly, according to one aspect of the invention a side tarpaulin wall system is provided which can be obtained by the said method.

Further advantages, properties, features, and developments of the claimed invention emerge from the following description of a preferred embodiment and from the dependent claims.

The invention is explained in more detail below with reference to the accompanying drawings.

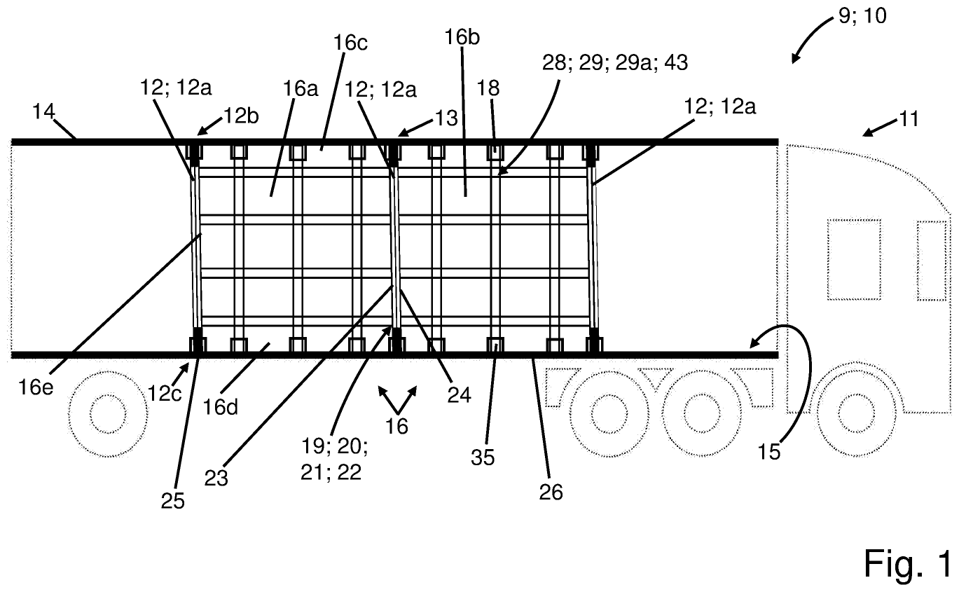

FIG. 1 shows a schematic side view of an exemplary embodiment of a side tarpaulin wall system for an utility vehicle.

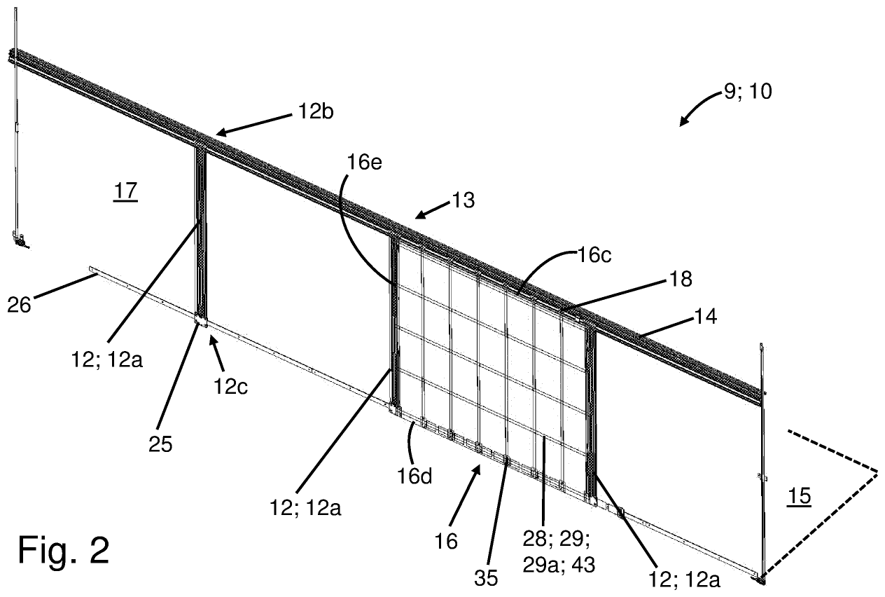

FIG. 2 shows a perspective view of a side tarpaulin wall system.

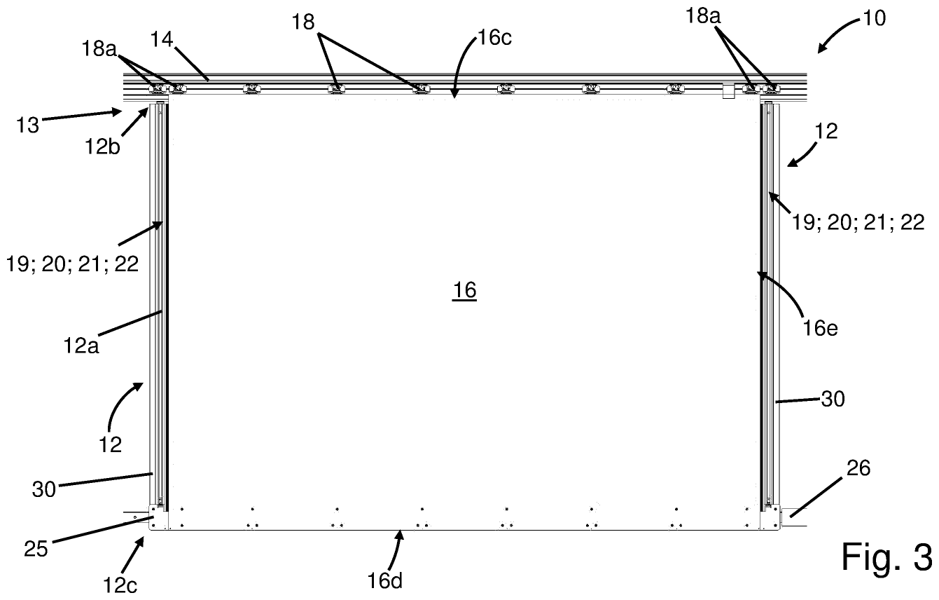

FIG. 3 schematically shows a front view of a connected tarpaulin segment of the side tarpaulin wall system.

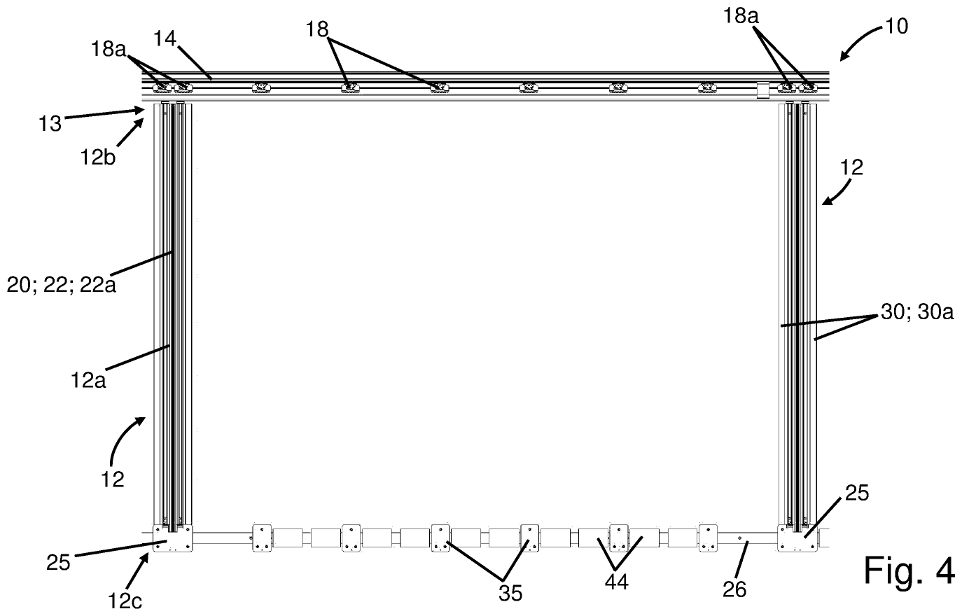

FIG. 4 shows FIG. 3 without a tarpaulin segment.

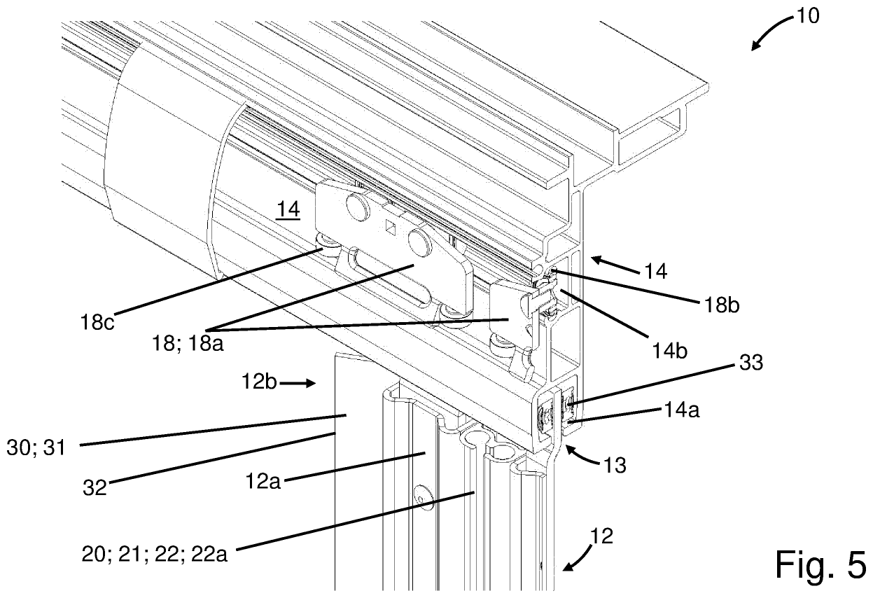

FIG. 5 shows a perspective sectional view of an exemplary embodiment of a connection of a sliding stanchion to a longitudinal beam.

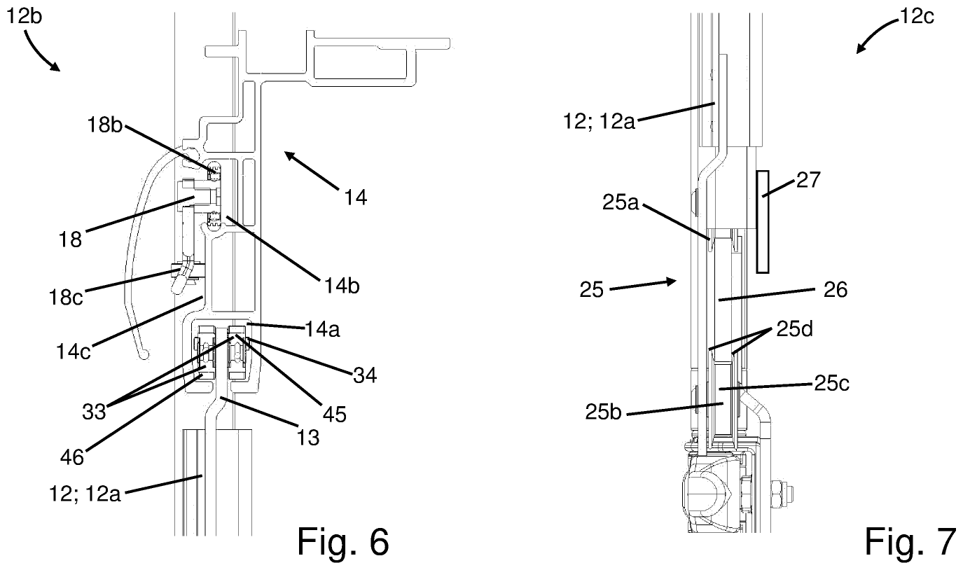

FIG. 6 shows the connection of FIG. 5 in a sectional view from the front.

FIG. 7 schematically shows an exemplary embodiment of a lower segment of a sliding stanchion in a sectional view from the front.

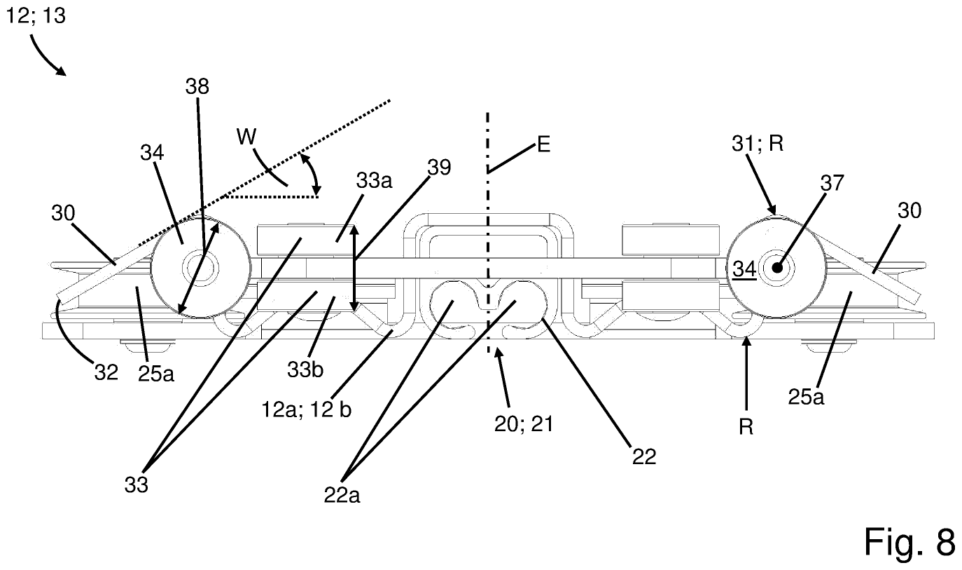

FIG. 8 shows a sliding stanchion with a stanchion suspension device from FIG. 5 in a plan view.

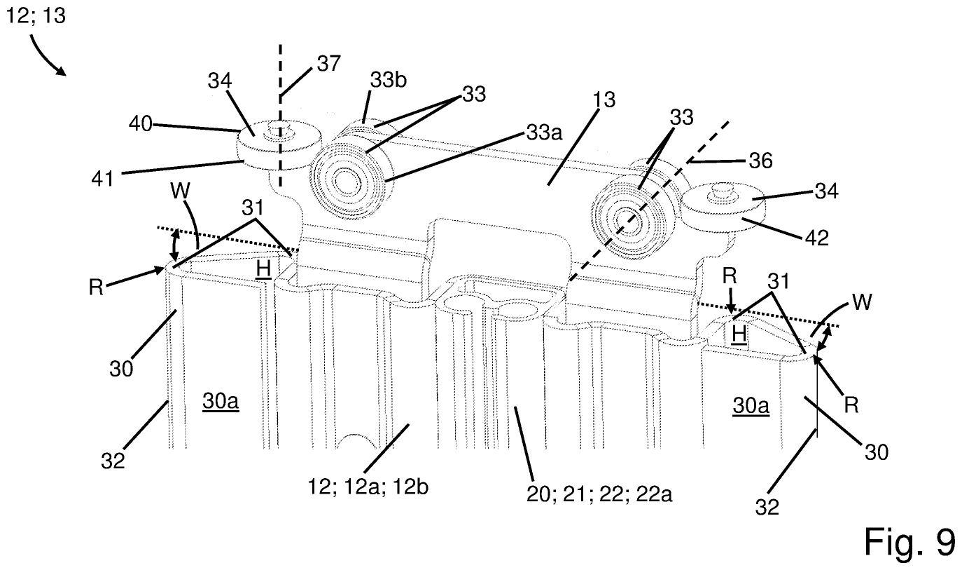

FIG. 9 shows a sliding stanchion with a stanchion suspension device from FIG. 5 in a perspective view.

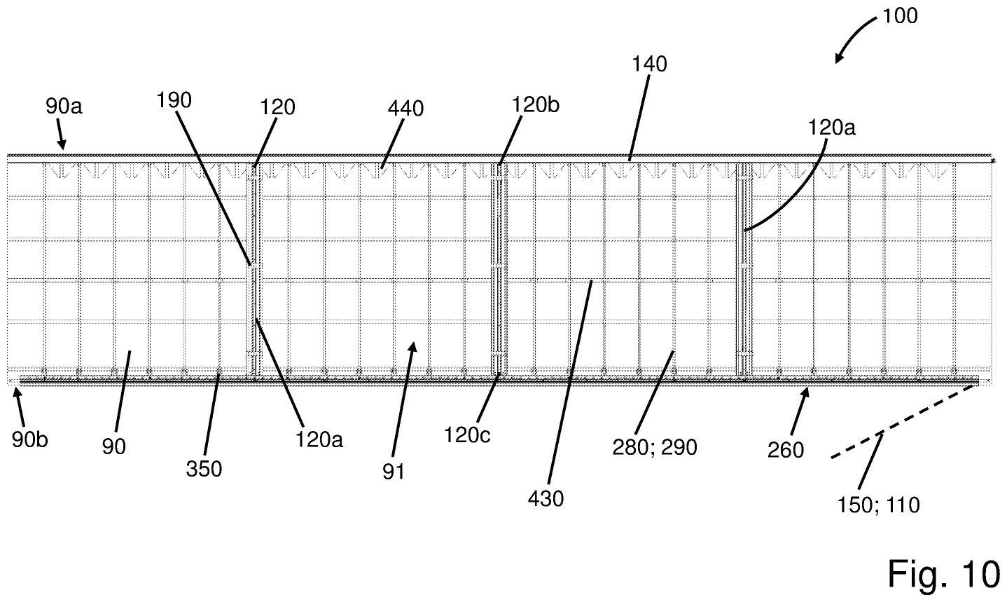

FIG. 10 shows a schematic side view of a further exemplary embodiment of a side tarpaulin wall system for an utility vehicle.

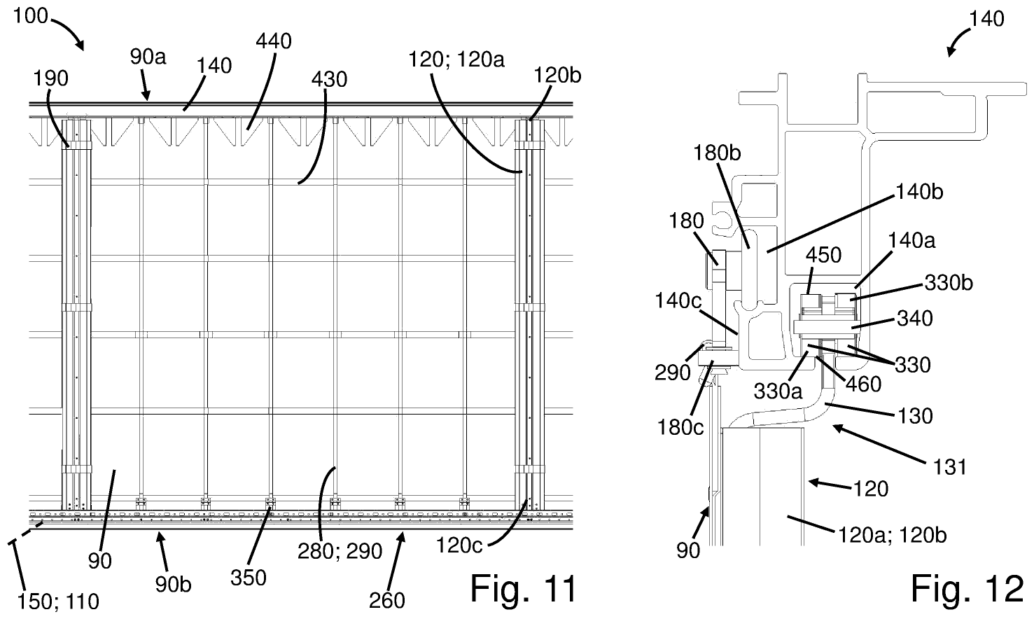

FIG. 11 shows an enlarged detail from FIG. 10.

FIG. 12 shows a schematic side view of a connection of a sliding stanchion with a longitudinal beam.

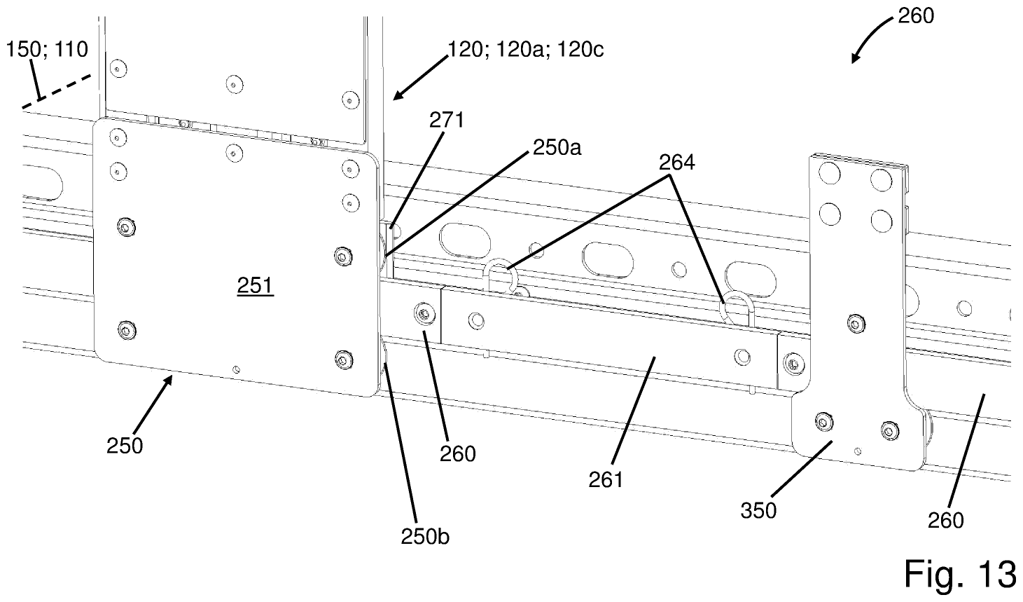

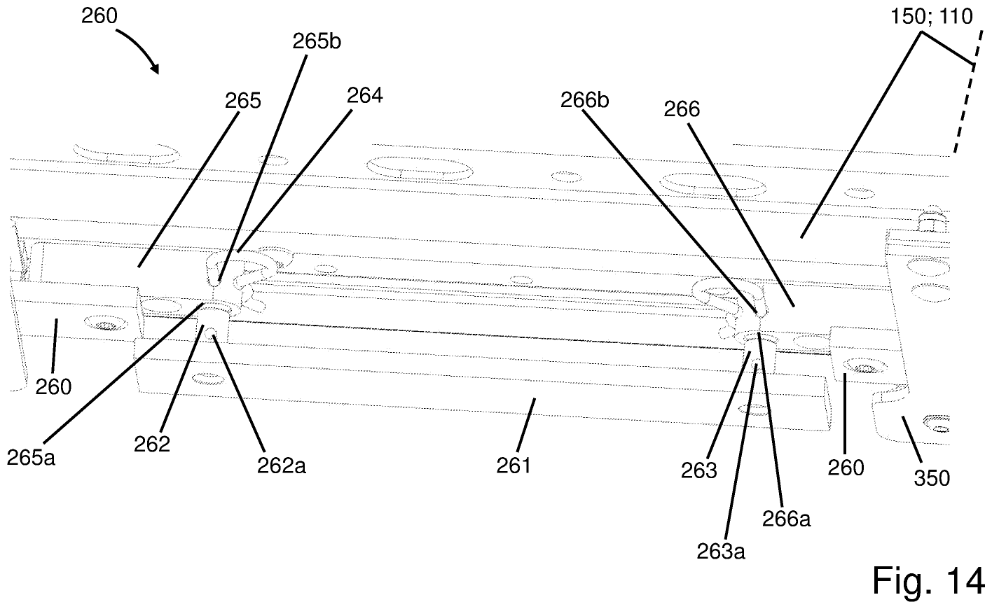

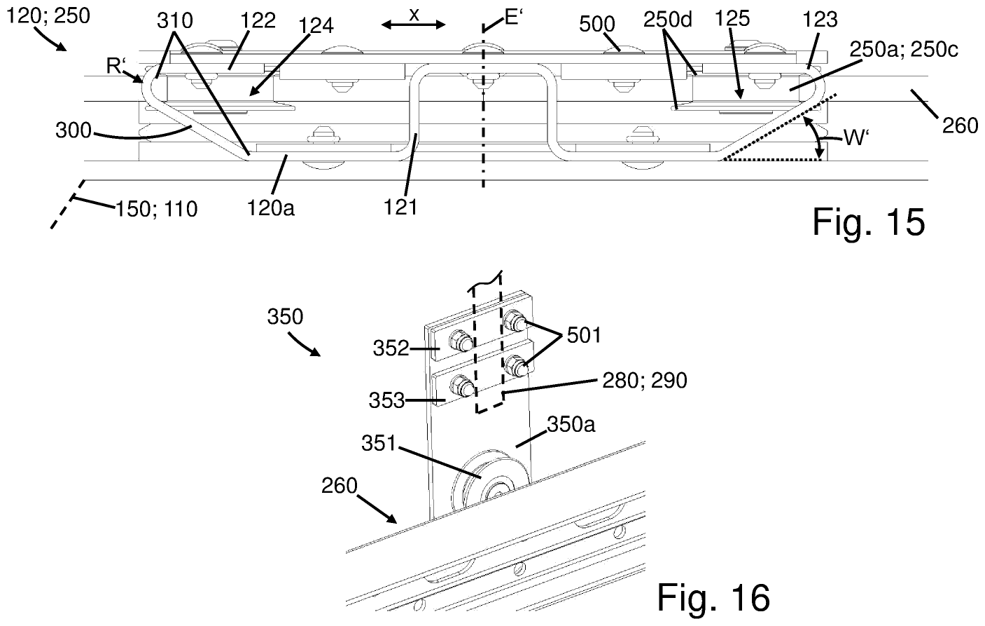

FIG. 13 shows a perspective view of a detail of a guide rail. shows a removable guide rail segment from FIG. 13. FIG. 14 shows a plan view of a cross-section of a sliding-stanchion FIG. 15 body.

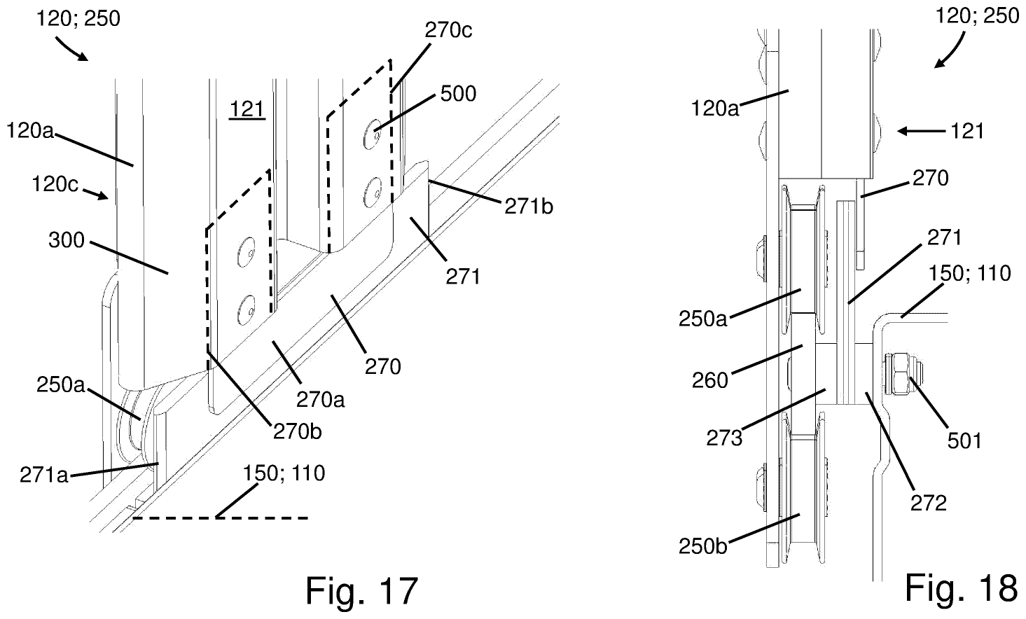

FIG. 16 shows a perspective view of a tarpaulin carriage. shows a perspective view of a lower end of a sliding FIG. 17 stanchion.

FIG. 18 shows a side view from FIG. 17.

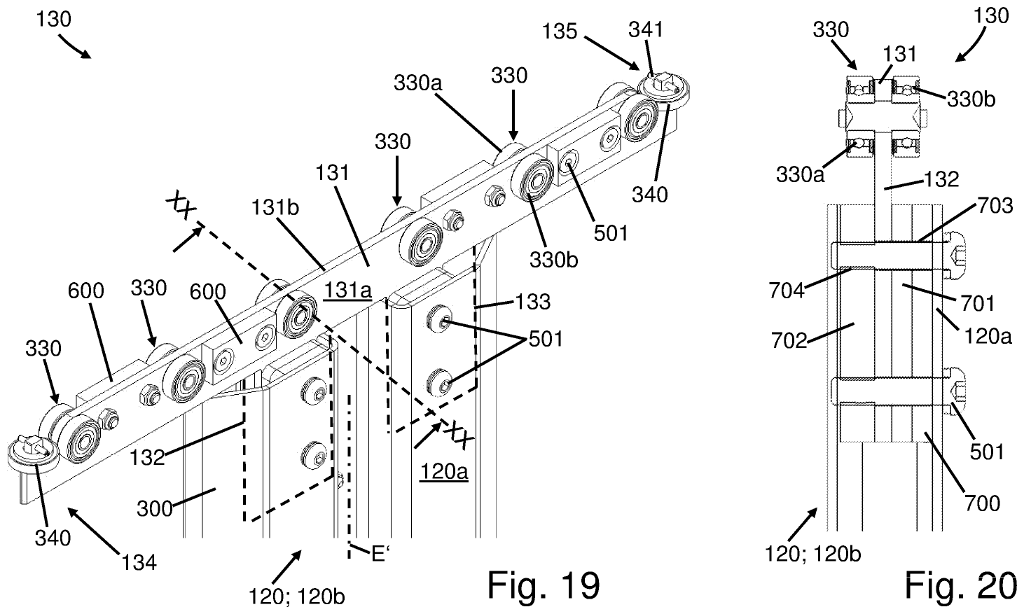

FIG. 19 shows a perspective rear view of an alternative stanchion suspension device for a sliding stanchion.

FIG. 20 shows a cross-section of the stanchion suspension device from FIG. 19.

FIG. 1 shows an exemplary embodiment of a side tarpaulin wall system 10. As an example, an utility vehicle 11 with a semitrailer is shown in FIG. 1 in a side view. The side tarpaulin wall system 10 is located between a longitudinal beam 14 and a guide rail 26 assigned to a loading platform 15. Furthermore, the side tarpaulin wall system 10 comprises a plurality of tarpaulin segments 16 which are located between vertical sliding stanchions 12. Here, FIG. 1 schematically shows a first tarpaulin segment 16a and a second tarpaulin segment 16b, which are each connected to sliding stanchions 12 via their vertical edge 16e.

A sliding stanchion 12 has a sliding-stanchion body 12a with an upper end 12b and a lower end 12c. Here, each sliding stanchion 12 is connected by means of a stanchion suspension device 13, which is displaceable within a first chamber 14a, shown in FIG. 5, of a longitudinal beam 14.

Furthermore, the sliding stanchion 12 has at its lower end 12c a sliding-stanchion carriage 25 which is displaceable along the guide rail 26. The sliding-stanchion body 12a comprises a keder rail 22 with a double groove 22a, which is shown in FIG. 5, FIG. 8, and FIG. 9. The keder rail 22, which is attached to the sliding stanchion 12, forms the counter-element 20 for a keder connection 21 with a tarpaulin segment 16.

Each tarpaulin segment 16 has an upper horizontal edge 16c and a lower horizontal edge 16d. Furthermore, each tarpaulin segment 16 comprises at least one vertical edge 16e on which a keder 23; 24 is arranged. The keder 23; 24 of the tarpaulin segment 16 forms the connecting element 19 of the tarpaulin segment 16 with the counter-element 20 of the sliding stanchion 12, so that the tarpaulin segment 16 can be connected to the sliding stanchion 12 via a keder connection 21.

The upper horizontal edge 16c of the tarpaulin segment 16 comprises tarpaulin suspension devices 18 and the lower horizontal edge 16d of the tarpaulin segment 16 comprises tarpaulin carriages 35. As a result, the tarpaulin segment 16 is displaceable along a second chamber 14b, shown in FIG. 5, of the longitudinal beam 14 via the tarpaulin suspension devices 18. Furthermore, the tarpaulin segment 16 is displaceable along the guide rail 26 via the tarpaulin carriages 35. A tarpaulin suspension device 18 is described in detail for example in DE 20 2015 006 044 U1, the disclosure of which is hereby incorporated by reference.

When a sliding stanchion 12, which is connected to a tarpaulin segment 16 via a keder connection 21, is displaced, a tensile force acts on the tarpaulin segment 16 along the vertical edge 16e. This tensile force is transferred to an adjacent sliding stanchion 12 so that this stanchion is also displaced, always in one displacement direction. A combination of the above described sliding stanchions 12 and tarpaulin segments 16 consequently forms an openable side tarpaulin 9 for an utility vehicle.

To ensure that the tarpaulin segment 16 is not overstretched and to ensure that the tarpaulin segment 16 has a certain sturdiness, the tarpaulin segment 16 comprises tensile reinforcements 28; 43 which are sewn to or welded into the tarpaulin segment.

The tensile reinforcements 28; 43 also have, at least in portions, straps 29; 29a. Advantageously, in the middle of the tensile reinforcements 28; 43 or strap strips 29; 29a the tarpaulin segment 16 is protected from overstretching.

Furthermore, the tensile reinforcements 28; 43 preferably serve as a folding aid. When the side tarpaulin wall system 10 is being opened, the sliding stanchions 12 are displaced and thus the tarpaulin segments 16 are also displaced. Here the tarpaulin segments 16 are folded together like an accordion.

FIG. 2 shows by way of example a perspective view of the side tarpaulin wall system 10. In this exemplary embodiment, it can be clearly seen that the tarpaulin segment 16 has tensile reinforcements 28; 43, which are arranged in a checkerboard pattern with the tarpaulin segment 16. Furthermore, the vertical tensile reinforcements 28; 43 are connected on one side in a region of the guide rail 26 to tarpaulin carriages 35 and on the other side in a region of the longitudinal beam 14 to tarpaulin suspension devices 18.

FIG. 3 shows an enlarged front view of a detail of the side tarpaulin wall system 10. The tarpaulin segment 16 is arranged in the middle and is framed by a sliding stanchion 12 at each of its vertical edges 16e. The upper horizontal edge 16c of the tarpaulin segment 16 is attached to tarpaulin suspension devices 18 as well as to lateral tarpaulin suspension devices 18a, which in turn are located in a second chamber 14b of the longitudinal beam 14. The lower horizontal edge 16d of the tarpaulin segment 16 is connected to tarpaulin carriages 35, which in FIG. 3 are covered by the tarpaulin segment 16.

The two vertical edges 16e of the tarpaulin segment 16 each have a keder 23; 24 which is located in a groove 22a of a keder rail 22. The keder rail 22 is arranged on a sliding stanchion 12 in the longitudinal direction and fastened to it by means of screws. A positive connection is established via the keder connection 21, so that a tensile force which is introduced from the sliding stanchion 12 onto the tarpaulin segment 16 can act uniformly over the entire vertical edge 16e of the tarpaulin segment 16. Furthermore, a tarpaulin segment 16 can transfer the same tensile forces to the sliding stanchion 12 via the keder connection 21. This depends on the direction of displacement of the side tarpaulin 9.

FIG. 4 shows the same illustration as FIG. 3, but without the tarpaulin segment 16. In FIG. 4, the two sliding stanchions 12 are fully visible in a front view, as are the lower tarpaulin carriages 35, which were previously covered by the tarpaulin segment 16.

Each sliding stanchion 12 has so-called guide elements 30; 30a along its sliding-stanchion body 12a in the longitudinal direction. In the event that a cargo within a cargo space is moved outside the loading platform 15, the sliding stanchion 12 can be easily guided past the cargo by means of the guide elements 30 during an opening or closing process.

FIG. 5 shows a detail of the upper region 12b of the sliding stanchion 12. In particular, the longitudinal beam 14 can be clearly seen; a section through the longitudinal beam 14 is shown, so that the first chamber 14a and the second chamber 14b of the longitudinal beam 14 are visible.

In FIG. 5, the sliding stanchion 12 is shown in such a way that the stanchion suspension device 13 is visible. The stanchion suspension device 13 is located on a side facing the loading platform 15. The stanchion suspension device 13 has load-bearing rollers 33a; 33b which are designed as twin load-bearing rollers 33 and which are displaceable in the first chamber 14a of the longitudinal beam 14.

Furthermore, FIG. 5 shows the tarpaulin suspension device 18, or the lateral tarpaulin suspension device 18a, with a total of two load-bearing rollers 18b, which are arranged and displaceable in a second chamber 14b of the longitudinal beam 14. Furthermore, each tarpaulin suspension device 18; 18a comprises two horizontal guide rollers 18c which are displaceable along an outer wall 14c of the longitudinal beam 14. It can be clearly seen that an angled bend 31 extends outward from the sliding-stanchion body 12a, which bend defines the guide element 30.

Furthermore, FIG. 5 clearly shows the keder rail 22, which is arranged centrally along the sliding-stanchion body 12a. The keder rail 22 comprises a double groove 22a in which a keder 23; 24 of a tarpaulin segment 16 can be mounted on the left and right respectively.

As a result, a first tarpaulin segment 16a and a second tarpaulin segment 16b can be connected to one sliding stanchion 12 via a first keder 23 and a second keder 24.

FIG. 6 shows a sectional view of the upper end 12b of the sliding-stanchion body 12a. The longitudinal beam 14 with its first chamber 14a and its second chamber 14b can be clearly seen, with both chambers 14a; 14b being arranged at a distance from one another. The stanchion suspension device 13 with the two twin load-bearing rollers 33, which in this view have an upper edge 45 and a lower edge 46, is arranged within the first chamber 14a.

The sliding stanchion 12 is arranged below the stanchion suspension device 13 and is connected to the stanchion suspension device 13 in a frictionally interlocking and positive-fitting manner. The tarpaulin suspension device 18; 18a is located in the second chamber 14b of the longitudinal beam 14. The tarpaulin suspension device 18; 18a has vertical load-bearing rollers 18b and horizontal guide rollers 18c. Here the horizontal guide roller 18c is guided on an outer wall 14c of the longitudinal beam 14. The outer wall 14c is arranged on a side facing away from the loading platform 15.

FIG. 7 shows the lower end 12c of the sliding-stanchion body 12a. At the lower end 12c, the sliding stanchion 12 has a sliding-stanchion carriage 25 which is displaceable along the guide rail 26. The sliding-stanchion carriage 25 comprises two upper load-bearing rollers 25a and a lower counter-roller 25b. The load-bearing rollers 25a and the counter-roller 25b each have a collar 25d projecting beyond a running surface 25c, so that the load-bearing rollers 25a and the counter-roller 25b can absorb horizontal forces without the load-bearing rollers 25a and the counter-roller 25b being able to be forced out of the guide rail 26.

Furthermore, FIG. 7 shows a stop body 27 which serves as additional protection for the sliding-stanchion carriage 25. The stop body 27 transmits horizontal forces, which can be caused in particular by a slipping cargo, into the sliding-stanchion body 12a, so that the sliding-stanchion carriage 25 of the sliding stanchion 12 is always connected to the guide rail 26 in a displaceable manner.

FIG. 8 shows the sliding stanchion 12 in a view from above. The sliding stanchion 12 has an overall mirror-symmetrical shape, characterized by the plane of symmetry E. The keder rail 22 is arranged centrally within the sliding stanchion 12. The keder rail 22 has a double groove 22a into which a keder 23; 24 of a first tarpaulin segment 16a and of a second tarpaulin segment 16b can be inserted. The double groove 22a of the keder rail 22 has overall an opening slot which extends along the keder rail 22. Each tarpaulin segment 16 emerges from this opening slot to the left or to the right.

It is important that the opening slot is narrow, so that the two emerging tarpaulin segments 16a; 16b have as small a gap as possible and are arranged flush with each other.

In particular, the stanchion-suspension device 13 can be clearly seen in FIG. 8. The stanchion-suspension device 13 has so-called twin load-bearing rollers 33, which are located to the left and right of the keder rail 22 in a vertical orientation. Each twin load-bearing roller 33 comprises a first load-bearing roller 33a and a second load-bearing roller 33b, each defining a width 39 and having an identical axis of rotation 36. Horizontal guide rollers 34 of the stanchion suspension device 13 are arranged on the outside in the direction of travel of the sliding stanchion 12 with respect to the twin load-bearing rollers 33. Furthermore, each guide roller 34 has a vertical axis of rotation 37. In addition, the guide rollers 34 have an outer diameter 38 that is larger than the width 39 of the twin load-bearing rollers 33.

FIG. 8 also shows a first exemplary embodiment of a guide element 30. The guide element 30 of the sliding stanchion 12 extends at a certain angle W from the sliding-stanchion body 12a. The guide element 30 is designed as a bend 31 with a radius R. Here, an outer edge 32 points in a direction towards a tarpaulin segment 16.

FIG. 9 shows an upper end 12b of the sliding stanchion 12 with a stanchion suspension device 13 connected to the sliding-stanchion body 12a. Both the twin load-bearing rollers 33 and the guide rollers 34 of the stanchion suspension device 13 are clearly visible, since the longitudinal beam 14 is not shown in FIG. 9. The horizontal guide rollers 34 of the stanchion suspension device 13 have an upper edge 40 and a lower edge 41 which are arranged on an outer peripheral surface 42 of the guide rollers 34.

In addition, a second exemplary embodiment of a guide element 30 of the sliding stanchion 12 is shown in FIG. 9. The guide element 30 has a total of three bends 31 of the sliding-stanchion body 12a. Each bend 31 has a radius R. The guide element 30 is bent from the sliding-stanchion body 12a at an angle W such that the guide element 30 forms a triangular cross-section which includes a cavity H. Here the outer edges 32 are each blunt in the direction of travel. Furthermore, the guide element 30 comprises a smooth front surface 30a, which is arranged on a side facing away from the loading platform 15.

The invention works as follows: The closed and latched side tarpaulin wall system 10 is unlocked at a corresponding point so that the side tarpaulin wall system 10 or the side tarpaulin 9 can be moved or opened. With the aid of a rod with a hook, the side tarpaulin wall system 10 can be opened manually via a strap loop. In this case, a user pulls the strap loop in an opening direction so that the sliding stanchions 12 and the tarpaulin segments 16 connected to the sliding stanchions 12 follow the strap loop in the opening direction.

When shifted in the opening direction, the tarpaulin segments 16 fold together like an accordion, so that the sliding stanchions 12 and the folded tarpaulin segments 16 are arranged in a corner of the utility vehicle 11, thereby releasing a lateral opening 17 of the utility vehicle 11.

In order to close the side tarpaulin wall system 10, a second strap loop arranged opposite, which is connected to another stanchion suspension device 13, is pulled manually in the other direction by means of the rod with a hook, so that the sliding stanchion 12 or the tarpaulin segment 16 follows the direction of displacement. The tarpaulin segments 16 unfold, thereby forming a smooth, flat wall. If the entire lateral opening 17 is covered with the side tarpaulin wall system 10, the side tarpaulin wall system 10 is latched and tensioned via a latching device and, if necessary, via a tensioning device. The utility vehicle 11 is now ready to drive off.

Should a cargo have slipped within the cargo space so as to represent an obstacle for the sliding stanchions 12, the sliding stanchions 12 can simply be guided past the obstacle by using their guide elements 30.

The side tarpaulin 9 or the side tarpaulin wall system 10 no longer serves simply as a cover. The side tarpaulin 9 is divided into a plurality of tarpaulin segments 16, which are directly connected to the sliding stanchions 12. In this way, the tarpaulin segment 16 takes on the function of a chain link between the sliding stanchions 12.

In the event of damage to a tarpaulin segment 16, it should be replaced by means of the following steps, by way of example. Here, a tarpaulin material is first cut into rectangular tarpaulin segments 16, wherein an upper horizontal edge 16c of the tarpaulin segment 16 is assigned to a longitudinal beam 14 and a lower horizontal edge 16d of the tarpaulin segment 16 is assigned to a guide rail 26.

In a next step, at least one keder 23; 24 is connected adjacent to the vertical edge 16e of the tarpaulin segment 16. This vertical edge 16e of the tarpaulin segment 16 is correspondingly assigned to the sliding stanchion 12. This is followed by inserting the keder 23; 24, which is connected to the tarpaulin segment 16 with a positive fit or with a material bond, into a groove 22a of a keder rail 22. The keder rail 22, which is connected to the tarpaulin segment 16, is then attached to the sliding stanchion 12 by rivets or screws.

The upper horizontal edge 16c of the tarpaulin segment 16 is connected to the tarpaulin suspension devices 18; 18a. The tarpaulin suspension devices 18; 18a are accordingly suspended within a second chamber 14b of the longitudinal beam 14 and are displaceable along the longitudinal beam 14.

In a final step, the tarpaulin segment 16 is connected to the tarpaulin carriages 35, which are displaceable along the guide rail 26 assigned to the loading platform 15. The entire side tarpaulin wall system 10 correspondingly has a modular construction, so that individual components can be exchanged and replaced very easily and quickly.

Furthermore, an automation of the side tarpaulin wall system 10 is possible so that the side tarpaulin wall system 10 can be opened and closed automatically via computer control.

FIG. 10 shows an alternative embodiment of an openable side tarpaulin wall system 100 for an utility vehicle 110, in which a wrinkle-free inner surface 91 of a closed side tarpaulin 90 is shown, wherein the inner surface 91 of the side tarpaulin 90 faces a loading platform 150 shown as a dashed line. In contrast to the previous exemplary embodiments, the side tarpaulin 90 in FIG. 10 does not have individual tarpaulin segments. The side tarpaulin 90 is now designed as a one-piece continuous side tarpaulin 90 or comprises only a single tarpaulin segment forming the side tarpaulin 90.

FIG. 11 shows an enlarged detail of the closed side tarpaulin wall system 100 from FIG. 10.

The side tarpaulin 90 according to FIG. 10 and FIG. 11 has an upper horizontal edge 90a which is assigned to a longitudinal beam 140, wherein in a region of the upper horizontal edge 90a the side tarpaulin 90 comprises tarpaulin suspension devices which are connected to the longitudinal beam 140 or are displaceable along the longitudinal beam 140, wherein, however, the tarpaulin suspension devices are not shown in FIG. 10 or FIG. 11. Furthermore, the side tarpaulin 90 has a lower horizontal edge 90b opposite the upper horizontal edge 90a, which lower edge is assigned to the loading platform 150 or to a guide rail 260.

Furthermore, the side tarpaulin wall system 100 shown in FIG. 10 and FIG. 11 comprises a plurality of sliding stanchions 120, each with a sliding-stanchion body 120a which has an upper end 120b and a lower end 120c, wherein the sliding stanchions 120 are displaceable along the longitudinal beam 140 and along the oppositely situated guide rail 260, which is fastened to the loading platform 150, via stanchion suspension devices and via sliding-stanchion carriages, although the stanchion suspension devices and the sliding-stanchion carriages are not shown in FIG. 10 and FIG. 11.

Furthermore, the side tarpaulin 90 has fastening elements 190 on the inner surface 91, such as hook-and-loop-fastener strips, which are arranged, among other things, in an upper, a central, and a lower region of the side tarpaulin 90. Furthermore, the side tarpaulin 90 is riveted to the sliding stanchions 120.

So that the side tarpaulin 90 can be folded or unfolded like an accordion during an opening or closing process of the side tarpaulin wall system 100, the side tarpaulin 90 has triangular plates 440 which are arranged along the upper edge 90a of the side tarpaulin 90. The triangular plates 440 are thus designed as a tarpaulin folding aid. Furthermore, the side tarpaulin 90 has metal strips 430 made of a steel material, which are arranged in horizontally aligned pockets in the longitudinal direction of the side tarpaulin 90, wherein the metal strips 430 support the folding and unfolding of the side tarpaulin 90. The metal strips 430 are thus arranged parallel to the longitudinal beam 140 or parallel to the guide rail 260 in a closed state of the side tarpaulin 90.

In order to give the side tarpaulin 90 good mechanical stability, which protects the side tarpaulin 90 from tearing, the side tarpaulin 90 has vertical straps 290 as a tensile reinforcement 280. The straps 290 are sewn to the side tarpaulin 90, wherein the straps 290 comprise an aramid-fiber-reinforced strap material. Furthermore, the side tarpaulin 90 is connected in a region along the lower horizontal edge 90b of the side tarpaulin 90 via the vertical straps 290 to tarpaulin carriages 350 which are connected to the guide rail 260 of the loading platform 150 and are displaceable along the guide rail 260. Furthermore, the side tarpaulin 90 is riveted to the tarpaulin carriages 350. The straps 290 are thus arranged parallel in relation to the sliding stanchions 120 when the side tarpaulin 90 is in the closed state. In addition, two triangular plates 440 are arranged between two adjacent vertical straps 290.

FIG. 12 shows a cross-section of the longitudinal beam 140, which has a first chamber 140a and a second chamber 140b. Within the first chamber 140a of the longitudinal beam 140, two twin load-bearing rollers 330 of the stanchion suspension device 130 are displaceably arranged in series. Each twin load-bearing roller 330 here comprises a first load-bearing roller 330a and a second load-bearing roller 330b. Furthermore, two guide rollers 340 of the stanchion suspension device 130 are displaceably arranged within the first chamber 140a. The guide rollers 340 are located outside the twin load-bearing rollers 330 in the direction of travel of the sliding stanchion 120. The arrangement of the twin load-bearing rollers 330 and of the guide rollers 340 of the stanchion suspension device 130 thus corresponds to the previous exemplary embodiments. Furthermore, the stanchion suspension device 130 has a bent portion 131 which is riveted to the sliding-stanchion body 120a at the upper end 120b of the sliding stanchion 120. As a result, the sliding stanchion 120 is arranged in the longitudinal beam 140 via the stanchion suspension device 130 and is guided so as to be displaceable along the longitudinal beam 140.

A load-bearing roller 180b of the tarpaulin suspension device 180 is displaceably arranged within the second chamber 140b of the longitudinal beam 140. Furthermore, the tarpaulin suspension device 180 comprises a guide roller 180c which is displaceable along an outer wall 140c of the longitudinal beam 140. The tarpaulin suspension device 180 further comprises a slot receptacle in which the vertical strap 290 is guided through in looped fashion and is in turn sewn to the side tarpaulin 90. As a result, the side tarpaulin 90 is thus arranged on the longitudinal beam 140 via the tarpaulin suspension devices 180 and is guided so as to be displaceable along the longitudinal beam 140.

FIG. 13 shows, in a perspective view, an enlarged detail of the guide rail 260 which is connected to the loading platform 150 of the utility vehicle 110. The guide rail 260 comprises at least one removable guide rail segment 261, which is secured against falling out by two securing elements 264.

The mounted guide rail segment 261 is aligned and flush with the remaining guide rail 260, so that the tarpaulin carriage 350 and the sliding-stanchion carriage 250 can be moved steplessly, without jamming, and smoothly. The purpose of the removable guide rail segment 261 is that the sliding-stanchion carriages 250 and the tarpaulin carriages 350 can be threaded out via a gap portion of the guide rail 260 in order, for example, to be able to lift a roof of the utility vehicle 110 without damaging the sliding stanchions 120 and the side tarpaulin 90.

Furthermore, FIG. 13 shows the lower end 120c of the sliding-stanchion body 120a of the sliding stanchion 120 with the connected sliding-stanchion carriage 250, wherein an upper load-bearing roller 250a and a lower counter-roller 250b of the sliding-stanchion carriage 250 can be seen. Here, the upper load-bearing roller 250a is arranged on top of a narrow side of the guide rail 260, wherein the lower counter-roller 250b is arranged on an opposite lower narrow side of the guide rail 260. The sliding-stanchion carriage 250 comprises a total of two load-bearing rollers 250a arranged in series and two counter-rollers 250b arranged in series which are riveted to the sliding-stanchion body 120a of the sliding stanchion 120 by means of a fastening plate 251.

Furthermore, an end-face portion of an end stop body 271 can be seen behind the upper load-bearing rollers 250a.

FIG. 14 shows in a perspective view a portion of the guide rail 260 with the removed guide rail segment 261, which segment has a first pin 262 and an opposite second pin 263, wherein the first pin 262 and the second pin 263 each extend orthogonally from the same broad side of the guide rail segment 261 in the same direction. It can be seen that the guide rail segment 261 is designed as an elongated flat piece with a rectangular cross-section. Furthermore, the first pin 262 and the second pin 263 each have a cylindrical shape, wherein the first pin 262 and the second pin 263 are welded to the guide rail segment 261.

Furthermore, the first pin 262 has a first hole 262a and the second pin 263 has a second hole 263a, wherein the first hole 262a and the second hole 263a are each arranged transversely to a longitudinal axis of the first pin 262 and to a longitudinal axis of the second pin 263, respectively.

In order to mount the guide rail segment 261 on the utility vehicle 110, the first pin 262 of the guide rail segment 261 is inserted into a first receptacle 265a of a first fastening element 265.

Furthermore, the second pin 263 of the guide rail segment 261 is inserted into a second receptacle 266a of a second fastening element 266.

The first fastening element 265 and the second fastening element 266 are connected to the loading platform 150 of the utility vehicle 110 via a screwed or riveted connection, wherein the first fastening element 265 and the second fastening element 266 each have a cuboid body, wherein a longitudinal side of the first fastening element 265 and of the second fastening element 266 are arranged parallel with respect to the loading platform 150.

The first receptacle 265a of the first fastening element 265 has a first through-hole 265b which is arranged transversely to the first receptacle 265a. The second receptacle 266a of the second fastening element 266 has a second through-hole 266b which is arranged transversely to the second receptacle 266a. The first pin 262 and the second pin 263 of the guide rail segment 261 are thus inserted via a plug-in connection into the first receptacle 265a and into the second receptacle 266a of the first fastening element 265 and the second fastening element 266. Here, the first hole 262a of the first pin 262 and the first hole 265b of the first receptacle 265a of the first fastening element 265 are arranged in alignment. Furthermore, the second hole 263a of the second pin 263 and the second hole 266b of the second receptacle 266a of the second fastening element 266 are arranged in alignment. A securing element 264, which is designed in each case as a spring pin, can thus be inserted into each of the aligned holes 262a, 265b; 263a; 266b in order to avoid an unwanted disintegration of the guide rail segment 261.

FIG. 15 shows a top view of a cross-section of the sliding-stanchion body 120a of the sliding stanchion 120, wherein an upper section of the sliding-stanchion carriage 250 can be seen, wherein two load-bearing rollers 250a of the sliding-stanchion carriage 250 can be seen, which rest with their running surface 250c on the guide rail 260. The guide rail 260 is connected laterally to a wall of the loading platform 150 of the utility vehicle 110 and the guide rail 260 extends in the longitudinal direction of the loading platform 150. Furthermore, the sliding-stanchion carriage 250 is connected to the sliding-stanchion body 120a by means of rivets 500.

The sliding-stanchion body 120a has an omega-shaped profile 121 in the middle, from which a first V-shaped profile portion 122 extends laterally in the longitudinal direction and from which a second V-shaped profile portion 123 extends laterally opposite, wherein a first V-opening 124 of the first V-shaped profile portion 122 and a second V-opening 125 of the second V-shaped profile portion 123 are directed towards each other, and wherein the first V-shaped profile portion 122 and the second V-shaped profile portion 123 are arranged away from the loading platform.

Furthermore, the sliding-stanchion body 120a is formed symmetrically along a longitudinal bisecting plane E′, wherein the sliding-stanchion body 120a has a guide element 300 formed as a bend 310 with a radius R′ on each side in the direction of travel x, which element extends from the lower end 120c to the upper end 120b of the sliding-stanchion body 120a. Furthermore, the guide element 300 of the sliding-stanchion body 120a forms an angle W′ with the loading platform 150.

The running surface 250c of the load-bearing roller 250a is arranged between two projecting collars 250d, wherein the collars 250d of the load-bearing rollers 250a each laterally enclose the guide rail 260 so that when forces occur that act on the sliding stanchion 120 perpendicular to a longitudinal axis of the guide rail 260, the load-bearing rollers 250a of the sliding-stanchion carriage 250 cannot slip laterally away from the guide rail 260 or derail.

FIG. 16 shows a perspective view of an inner surface 350a of the tarpaulin carriage 350, wherein a load-bearing roller 351 of the tarpaulin carriage 350 rests on top of the guide rail 260. The tarpaulin carriage 350 comprises a first clamping element 352 and a second clamping element 353, which are each detachably connected to the tarpaulin carriage 350 by means of screws 501.

The first clamping element 352 and the second clamping element 353 are formed as flat pieces made of a steel material with a rectangular cross-section. The first clamping element 352 and the second clamping element 353 each have a broad side and a narrow side, wherein the broad side of the first clamping element 352 or of the second clamping element 353 is arranged parallel with respect to the inner surface 350a of the tarpaulin carriage 350. The strap 290, which is designed as a tensile reinforcement 280 and is represented by dashed lines, is frictionally connected via a clamping between the inner surface 350a of the tarpaulin carriage 350 and the first clamping element 352 or the second clamping element 353.

FIG. 17 shows in a perspective view the lower end 120c of the sliding stanchion 120 with the connected sliding-stanchion carriage 250, wherein a stop body 270 projects from the sliding-stanchion body 120a, which stop body is aligned in a direction towards the loading platform 150 of the utility vehicle 110.

The stop body 270 is formed as a U-shaped flat piece made of a steel material with a base 270a connecting a first leg 270b and a second leg 270c, wherein the first leg 270b and the second leg 270c are riveted to the sliding-stanchion body 120a and the base 270a of the stop body 270 projects downward from the sliding-stanchion body 120a, so that the stop body 270 is arranged perpendicularly with respect to the loading platform 150. Here, the first leg 270b and the second leg 270c of the stop body 270 are each represented by dashed lines.

Furthermore, an end stop body 271 is arranged between the load-bearing roller 250a of the sliding-stanchion carriage 250 and the stop body 270. The end stop body 271 is formed as a flat piece of a steel material with a rectangular cross-section, wherein the end stop body 271 has a broad side and a narrow side, and wherein the end stop body 271 is arranged parallel with respect to the stop body 270. In addition, the end stop body 271 has a first end face 271a and an opposite second end face 271b, wherein the first end face 271a and the second end face 271b are each chamfered in a V-shape, so that the first end face 271a and the second end face 271b are each formed in the shape of a cutting edge. This facilitates threading of the end stop body 271 between the load-bearing rollers 250a of the sliding-stanchion carriage 250 and the stop body 270 when the sliding stanchion 120 is displaced. A position of the end stop body 271 in a region of the loading platform 150 corresponds to an end position of the sliding stanchion 120 assigned to the end stop body 271 when the side tarpaulin 90 is completely closed.

Thus, in the ready-to-drive final position the sliding stanchion 120 is very well secured against occurring horizontal forces which run substantially perpendicular to the longitudinal direction of the loading platform 150 and which act on an inner side 121 of the sliding stanchion 120. In the event that forces act on an inner side 121 of the sliding stanchion 120, the stop body 270 strikes the end stop body 271 so that, among other things, the load-bearing rollers 250a of the sliding stanchion carriage 250 are not damaged.

FIG. 18 shows a side view of the sliding-stanchion body 120a and the sliding-stanchion carriage 250 of the sliding stanchion 120, wherein the sliding-stanchion carriage 250 comprises two upper load-bearing rollers 250a arranged in series and two opposite lower counter-rollers 250b arranged in series, wherein the upper load-bearing rollers 250a and the lower counter-rollers 250b are identical.

The guide rail 260 is arranged between the upper load-bearing rollers 250a and the lower counter-rollers 250b and is connected to the loading platform 150 of the utility vehicle 110 via a screwed connection. A first clamping jaw 272 and a second clamping jaw 273 are arranged between the guide rail 260 and the loading platform 150, which jaws fasten the end stop body 271 in clamping fashion, after which the end stop body 271 is fixedly connected in this way to the guide rail 260 or to the loading platform 150. Here, the end stop body 271 is arranged between the first clamping jaw 272 and the second clamping jaw 273.

Furthermore, the loading platform 150, the first clamping jaw 272, the second clamping jaw 273, the end stop body 271 and the guide rail 260 each have at least one hole. The loading platform 150, the first clamping jaw 272, the second clamping jaw 273, the end stop body 271, and the guide rail 260 are arranged such that the holes are aligned with one another, so that a screw 501 is inserted into the holes, whereby the loading platform 150, the first clamping jaw 272, the second clamping jaw 273, the end stop body 271, and the guide rail 260 are connected to one another via a screwed connection.

Furthermore, the stop body 270 of the sliding stanchion 120 can be seen, which stop body is arranged between the end stop body 271 and the loading platform 150 and which projects from the sliding stanchion body 120a in a downward direction toward the first clamping jaw 272.

FIG. 19 schematically shows, in a perspective rear view, an alternative stanchion suspension device 130 for a sliding stanchion 120, which is connected to an upper end 120b of the sliding-stanchion body 120a of the sliding stanchion 120 via four screwed connections by means of screws 501.

The stanchion suspension device 130 comprises an elongated stanchion suspension device body 131 designed as a flat piece, from which a first tab 132 and a second tab 133 extend downward in the same direction toward the sliding-stanchion body 120a. The first tab 132 and the second tab 133 are represented by dashed lines.

Furthermore, the stanchion suspension device body 131, the first tab 132 and the second tab 133 are made in one piece from a steel sheet, wherein production takes place via a laser-cutting process. Furthermore, the stanchion suspension device body 131 comprises a broad side 131a and a narrow side 131b, wherein the broad side 131a of the stanchion suspension device body 131 is arranged parallel with respect to the sliding-stanchion body 120a. Furthermore, the stanchion suspension device 130 is designed to be mirror-symmetrical with respect to a central longitudinal bisecting plane E′ of the sliding-stanchion body 120a of the sliding stanchion 120.

The first tab 132 and the second tab 133 of the stanchion suspension device 130 are arranged in a clamping manner within the sliding-stanchion body 120a, wherein a fastening of the stanchion suspension device 130 to the sliding-stanchion body 120a is explained in more detail below with reference to FIG. 20.

The stanchion suspension device 130 now comprises six vertical twin load-bearing rollers 330, which are arranged in series one after the other along the stanchion suspension device body 131, wherein a load-bearing roller 330a; 330b of each twin load-bearing roller 330 is arranged on a broad side 131a of the stanchion suspension device body 131, so that the stanchion suspension device body 131 is designed as a partition wall which is arranged in each case between the first load-bearing roller 330a and the second load-bearing roller 330b of the corresponding twin load-bearing roller 330.

The stanchion suspension device body 131 has a first end 134 and an opposite second end 135 in the longitudinal direction, wherein a horizontal guide roller 340 is arranged at the first end 134 and at the second end 135 of the stanchion suspension device body 131, in each case in the direction of travel of the sliding stanchion 120. Here, all twin load-bearing rollers 330 are arranged between the two horizontal guide rollers 340, wherein the two guide rollers 340 are further each secured to a corresponding pin by means of a locking pin 341.

Furthermore, the stanchion suspension device 130 comprises four so-called wear blocks 600. When the side tarpaulin 90 is closed during travel of the utility vehicle 110, the load-bearing rollers 330a; 330b of the twin load-bearing rollers 330 work their way into the running surface of the first chamber 140a of the longitudinal beam 140, which is made of aluminum, due to vibrations and due to the deadweight of the sliding stanchion 120.

Over time, this creates a point-like dent in the running surface of the longitudinal beam 140. In order to counteract further pressing of the load-bearing rollers 330a; 330b of the twin load-bearing rollers 330 into the running surface, so-called wear blocks 600 are fastened to the stanchion suspension device body 131 of the stanchion suspension device 130 via a screwed connection by means of screws 501. As a result, starting from a defined dent depth of e.g. 1 mm the wear blocks 600 rest with a lower side on the running surface of the longitudinal beam 140, so that further progressive pressing of the load-bearing rollers 330a; 330b of the twin load-bearing rollers 330 into the running surface is prevented. The wear blocks 600 thus have the function of carrying or supporting the load-bearing rollers 330a; 330b of the twin load-bearing rollers 330 during travel operation.

The wear blocks 600 are each arranged between two first load-bearing rollers 330a of the corresponding twin load-bearing rollers 330 and/or between two second load-bearing rollers 330b of the corresponding twin load-bearing rollers 330.

Furthermore, the wear blocks 600 are made of a plastic, so that the wear blocks 600 can preferably be manufactured cost-effectively by means of an injection-molding process. The wear blocks 600 can, however, also be made of a steel material. The wear blocks 600 are each cuboid, with a broad side of the wear block 600 being arranged longitudinally parallel to the stanchion suspension device body 131.

FIG. 20 shows a cross-sectional view of the stanchion suspension device 130 along the line XX-XX in FIG. 19. Here, the first tab 132 of the stanchion suspension device 130 can be seen, which extends from the stanchion suspension device body 131 downwards in the direction of the sliding-stanchion body 120a of the sliding stanchion 120.

Furthermore, the first tab 132 is connected to the sliding-stanchion body 120a via a screwed connection by means of screws 501. For this purpose, the tab 132 is arranged parallel between a double clamping plate, which comprises a first clamping plate 700 and a second clamping plate 701, and a third clamping plate 702.

The sliding-stanchion body 120a, the first clamping plate 700, the second clamping plate 701 and the tab 132 each have an opening 703 in which a screw 501 with an external thread portion can be inserted in a direction transverse to the longitudinal direction of the sliding-stanchion body 120a. The third clamping plate 702 has an internally threaded hole 704, so that the screw 501 is mounted with its external thread portion within the internally threaded hole 704 in a frictionally locking and positive-locking manner, in that the external thread of the screw 501 engages with the internal thread of the internally threaded hole 704. For this purpose, the openings 703 and the corresponding internal threaded hole 704 are arranged in alignment.

The second tab 133 is correspondingly mounted on the sliding-stanchion body 120a according the first tab 132. Here, the first tab 132 and the second tab 133 each comprise two screws 501 for a stable fastening to the sliding-stanchion body 120a, wherein the first tab 132 and the second tab 133 are each connected by clamping to the sliding-stanchion body 120a.

The invention has been described above on the basis of a plurality of exemplary embodiments. It is understood that the features of the exemplary embodiments can also be combined individually or in their entirety, which combinations are hereby expressly stated as part of the disclosure of the present application.

1-15. (canceled)

16. An openable side tarpaulin wall system for a utility vehicle, comprising:
at least one sliding stanchion with a stanchion suspension device which is displaceable along a first chamber of a longitudinal beam, wherein said longitudinal beam is supported against a loading platform of the utility vehicle, and
a tarpaulin closing a lateral opening of the utility vehicle,
wherein said tarpaulin is suspended via tarpaulin suspension devices, wherein the tarpaulin suspension devices are displaceable along a second chamber of the longitudinal beam,
wherein the stanchion suspension device comprises at least two twin load-bearing rollers,
wherein the stanchion suspension device comprises a guide roller outside each of the twin load-bearing rollers in the direction of travel, wherein said guide rollers and said twin load-bearing rollers are arranged in the first chamber of the longitudinal beam,
wherein the sliding stanchion comprises a sliding-stanchion carriage at an end opposite the stanchion suspension device,
wherein the sliding stanchion is displaceable via said sliding-stanchion carriage with respect to a guide rail assigned to the loading platform,
wherein the tarpaulin comprises tarpaulin carriages at an end opposite the tarpaulin suspension devices, with which tarpaulin carriages the tarpaulin segment is displaceable with respect to said guide rail assigned to the loading platform.

17. The openable side tarpaulin wall system according to claim 16, wherein the tarpaulin carriages and the sliding-stanchion carriages are displaceable on the same guide rail.

18. The openable side tarpaulin wall system according to claim 16, wherein the sliding-stanchion carriages each have at least one load-bearing roller arranged above the guide rail and at least one counter-roller arranged below the guide rail, and wherein the tarpaulin carriages each have at least one load-bearing roller arranged above the guide rail and at least one counter-roller arranged below the guide rail.

19. The openable side tarpaulin wall system according to claim 18, wherein the load-bearing rollers and the counter-rollers comprise a central running surface being in contact with a narrow side of the guide rail, and wherein said load-bearing rollers and said counter-rollers are provided with a radially projecting collar on both sides of the running surface, which can be brought into contact with a broad side of the guide rail in order to absorb horizontal forces.

20. The openable side tarpaulin wall system according to claim 16, wherein further twin load-bearing rollers are arranged between the at least two twin load-bearing rollers adjacent to the guide rollers.

21. The openable side tarpaulin wall system according to claim 16, wherein the first chamber is spaced apart from the second chamber.

22. The openable side tarpaulin wall system according to claim 16, wherein the tarpaulin comprises a strap material, and wherein the strap material is connected to one of the tarpaulin suspension devices.

23. The openable side tarpaulin wall system according to claim 16, wherein the tarpaulin suspension device comprises a guide roller, wherein said guide roller is supported against an outer wall of the longitudinal beam, and wherein the outer wall of the longitudinal beam is arranged above the first chamber of the longitudinal beam.

24. A sliding stanchion for an openable side tarpaulin wall system for a utility vehicle, comprising
a sliding-stanchion body with an upper end and a lower end,
wherein the upper end of the sliding-stanchion body comprises a stanchion suspension device,
wherein the stanchion suspension device comprises at least two twin load-bearing rollers and at least one guide roller,
wherein the twin load-bearing rollers and said guide roller are displaceable in a first chamber of a longitudinal beam,
wherein the stanchion suspension device comprises a guide roller outside each of said twin load-bearing rollers in a direction of travel,
wherein the sliding stanchion comprises a sliding-stanchion carriage at an end opposite the stanchion suspension device, with which sliding-stanchion carriage the sliding stanchion is displaceable with respect to a guide rail assigned to a loading platform of the utility vehicle,
wherein the sliding-stanchion carriage comprises at least one load-bearing roller arranged above and at least one counter-roller arranged below with respect to said guide rail.

25. The sliding stanchion according to claim 24, wherein the load-bearing rollers and the counter-rollers comprise a central running surface being in contact with a narrow side of the guide rail, and wherein said load-bearing rollers and said counter-rollers are provided with a radially projecting collar on both sides of the running surface, which can be brought into contact with a broad side of the guide rail in order to absorb horizontal forces.

26. The sliding stanchion according to claim 24, wherein further twin load-bearing rollers are arranged between the at least two twin load-bearing rollers adjacent to the guide rollers.

27. The sliding stanchion according to claim 24, wherein the guide roller is arranged below an upper edge of the twin load-bearing rollers and above a lower edge of the twin load-bearing rollers.

28. The sliding stanchion according to claim 24, wherein the twin load-bearing rollers each have a horizontal axis of rotation and wherein the guide rollers each have a vertical axis of rotation.

29. The sliding stanchion according to claim 24, wherein an outer diameter of the guide roller projects beyond a width of the twin load-bearing rollers.

30. The sliding stanchion according to claim 24, wherein the sliding stanchion comprises, at least in portions, at least one guide element extending from an edge of said sliding-stanchion body, wherein said guide element is oriented outward in a direction away from the loading platform.

31. The sliding stanchion according to claim 24, wherein the guide rollers of said stanchion suspension device are arranged flush with each other.

32. An openable side tarpaulin wall system for a utility vehicle, comprising a longitudinal beam supported against a loading platform of the utility vehicle;
a plurality of sliding stanchions; and
a tarpaulin closing a lateral opening of the utility vehicle below said longitudinal beam;
wherein said plurality of sliding stanchions is attached to said tarpaulin,
wherein each of said plurality of sliding stanchions comprises an upper stanchion suspension device,
wherein the upper stanchion suspension device is displaceable along a first chamber of said longitudinal beam,
wherein the stanchion suspension device comprises a plurality of load-bearing twin rollers having a horizontal axis of rotation,
wherein the stanchion suspension device comprises a leading guide roller and a trailing guide roller, each of said leading and trailing guide rollers having a vertical axis of rotation and being arranged in said first chamber,
wherein the leading guide roller is arranged before said plurality of load-bearing twin rollers of the stanchion suspension device in a direction of travel of the stanchion suspension device,
wherein the trailing guide roller is arranged behind said plurality of load-bearing twin rollers of the stanchion suspension device in a direction of travel of the stanchion suspension device,
wherein the sliding stanchions comprise a lower sliding-stanchion carriage at an end opposite the stanchion suspension device,
wherein the sliding-stanchion carriage is displaceable with respect to a guide rail assigned to the loading platform,
wherein said tarpaulin is suspended to a plurality of tarpaulin suspension devices attached to said tarpaulin,
wherein the tarpaulin suspension devices are displaceable along a second chamber of said beam,
wherein the tarpaulin comprises a plurality of tarpaulin carriages,
wherein the tarpaulin carriages are arranged opposite said tarpaulin suspension devices,
wherein the tarpaulin carriages of the tarpaulin are displaceable with respect to said guide rail assigned to the loading platform.

33. The openable side tarpaulin wall system according to claim 32, wherein a plurality of straps is attached to said tarpaulin, wherein the straps each extend in a vertical direction, wherein the strap is attached at an upper strap end to one of said tarpaulin suspension devices, and wherein the strap is attached at a lower strap end to one of said carriages, such that the strap transmits vertical forces between said beam and said guide rail.

34. The openable side tarpaulin wall system according to claim 33, wherein the tarpaulin carriage comprises a first clamping element and a second clamping element, wherein said first clamping element and said second clamping element are each detachably connected to an inner surface of said tarpaulin carriage, wherein the lower strap end is frictionally connected between the inner surface of the tarpaulin carriage and one of said first clamping element and said second clamping element.

35. The openable side tarpaulin wall system according to claim 32, wherein said first chamber is arranged in a lower portion of said beam, wherein said second chamber is arranged in a lateral portion of said beam, wherein the tarpaulin suspension device comprises two load-bearing rollers having a horizontal axis of rotation, wherein the tarpaulin suspension device comprises two guide rollers having a vertical axis of rotation, wherein the guide rollers are supported against an exterior portion of said beam, wherein the load-bearing rollers of the tarpaulin suspension device are supported on a first track in said first chamber, wherein the load-bearing rollers of the tarpaulin suspension device are supported on a second track in said second chamber, and wherein said first track has a lower vertical position in said beam than said second track.
